(19) United States
(12) Patent Application Publication
(10) Pub. No.: US 2007/0122755 A1
(43) Pub. Date: May 31, 2007

(54) Heat developable photosensitive material including a combination of specified reducing agents

(76) Inventor: Yasuhiro Yoshioka, Kanagawa (JP)

Correspondence Address: TAIYO CORPORATION, 401 HOLLAND LANE, #407, ALEXANDRIA, VA, 22314, US

(21) Appl. No.: 11/593,571

(22) Filed: Nov. 7, 2006

Related U.S. Application Data
(63) Continuation-in-part of application No. 10/635,540, filed on Aug. 7, 2003, now abandoned.
(63) Continuation-in-part of application No. 10/643,221, filed on Aug. 19, 2003.
(63) Continuation-in-part of application No. 11/392,877, filed on Mar. 30, 2006.

(30) Foreign Application Priority Data
Aug. 12, 2002 (JP) 2002-234717
Apr. 2, 2002 (JP) 2002-099888
Apr. 3, 2002 (JP) 2002-101654
Oct. 24, 2002 (JP) 2002-309163
Dec. 5, 2002 (JP) 2002-353235
Oct. 26, 1999 (JP) 11-304347
Jan. 28, 2000 (JP) 2000-020744

(51) Int. Cl. G03C 5/16

(52) U.S. Cl. 430/348

(57) ABSTRACT

The invention provides a heat developable photosensitive material including a substrate, and at least one constituent layer which contains a photosensitive silver halide, a non-photosensitive organic silver salt, a reducing agent for thermal developing and a binder. The material includes at least one reducing agent that does not form a dye at the time of thermal developing and at least one reducing forming a dye at the time of thermal developing, and the dye-forming reducing agent is more active than the reducing agent that does not form a dye at the time of thermal developing.

### CROSS-REFERENCE TO RELATED APPLICATION

This application is a continuation-in-part application of, and claims priority to, U.S. patent application Ser. Nos. 10/635,540, 10/643,221 and 11/392,877, the disclosures of which are incorporated by reference herein. This application claims priority under 35 U.S.C. 119 from Japanese Patent Application No. 2002-234717, the disclosure of which is incorporated by reference herein.

### BACKGROUND OF THE INVENTION

1. Field of the Invention

The present invention relates to a heat developable photosensitive material. More particularly, the present invention relates to a heat developable photosensitive material showing minimal tonal change despite fluctuations in thermal developing time or temperature, and providing a stable finished image.

2. Description of the Related Art

In recent years, dry photo-processing systems have come into strong demand in the medical and printing platemaking fields in view of environmental safety and the desire to save space. Digitalization is rapidly progressing in these fields, hence digital systems for downloading image data to computers, saving the data and, if necessary, processing the data have come to be widely used. These systems can transmit image data to a location where the data is required, print the image data out onto a photosensitive material with a laser image setter or a laser imager, and then develop the image on the spot. These systems require photosensitive materials onto which data can be recorded via exposure to high-intensity lasers, producing clear precise black images with high resolution. Hard copy systems for printing on such digital imaging recording materials include ink-jet printing and electrophotographic systems, and these common image-forming systems utilize dyes and pigments for printing. However, these systems do not provide sufficient image quality (e.g., sharpness, graininess, gradation, and tone) essential to precise fields such as medical diagnostic imaging, and sufficient recording speed (sensitivity). Therefore, they have yet to reach the level of quality attained with conventional medical silver halide films developed by wet processing.

Thermal image forming systems utilizing organic silver salts are disclosed in U.S. Pat. Nos. 3,152,904 and 3,457,075 and in “Thermally Processed Silver Systems”, B. Shely, Imaging Processes and Materials, Neblette 8th edition, edited by Sturge, V. Walworth and A. Shepp, p. 2 (1996).

A heat developable photosensitive material generally has a photosensitive layer in which a photosensitive silver halide, a reducing agent, a reducible silver salt (e.g., an organic silver salt) and a toning agent for regulating the color of silver when necessary are dispersed in a matrix binder. For the binder, a polymer having a glass transition temperature lower than the temperature reached during thermal developing is utilized. Polyvinyl butyral is commonly employed for this purpose, and the image forming layer is often prepared by dissolving the binder in an organic solvent such as methyl ethyl ketone (MEK), then dispersing or dissolving materials such as the photosensitive silver halide, reducing agent, and organic silver salt therein and coating and drying a film on a substrate. Meanwhile, a heat developable photosensitive material employing a polymer latex binder has recently been developed.

The heat developable photosensitive material is heated to a high temperature (e.g., 80° C. or higher) after image exposure, whereby a black silver image is formed by a redox reaction between a silver halide or a reducible silver salt acting as an oxidizing agent and a reducing agent. The redox reaction is accelerated by catalysis of a silver halide latent image formed by exposure to light, thereby forming the black silver image in the exposed area. Heat developable photosensitive materials subjected to the above process are described in various references, including U.S. Pat. No. 2,910,377 and Japanese Patent Application Publication (JP-B) No. 43-4924. However, such materials have been associated with a major drawback in that a print-out phenomenon during storage of the image occurs, resulting in an increased fog level. This is due to the fact that residues of components such as the photosensitive silver halide, the organic silver salt, and the reducing agent remain even after the thermal developing process.

In the heat developable photosensitive material, an image is formed by developed silver particles generated by thermal developing, and the developed silver is known to change the color tone of the image, depending on the shape or surface condition. In the filed of medical diagnostic imaging, a cold-toned silver image (i.e., a bluish tone) tends to be preferred because it enables accurate diagnosis and various investigations have been made in order to control the color tone of silver images. For example, Japanese Patent Application Laid-Open (JP-A) No. 2000-241927 describes a method of controlling silver color tone by regulating the ammonium ion and sodium ion content of the photosensitive material. Although this method makes color tone control possible to a certain extent, the increase in the proportion of sodium ions for realizing a yellowish color tone simultaneously decreases a cyan color tone, hence full control of color tone is limited. Further, photographic performance such as sensitivity and maximum image density are also simultaneously affected, and the practical application of such methods have been limited.

Furthermore, JP-A No. 2001-188314 describes a method of controlling the color tone of an image by selecting a certain type of the reducing agent. Another application, JP-A No. 2002-169249, describes a method of controlling image color tone by employing a hindered phenol compound. Evidently, these methods make control of the image at a preferred color tone possible, and provide a remarkably wide control range when the aforementioned regulation with the sodium and ammonium ions is used in combination therewith. Accordingly, from a practical application standpoint, these are highly valuable technologies.

These methods make obtaining preferred color tone under specified developing conditions possible, however, color tone changes and deviates from preferred ranges with variances in the developing conditions such as developing temperature or developing time. Although the developing temperature and time are managed in the thermal developing apparatus, certain variations or fluctuations, which cause fluctuation in the finished color tone, are inevitable. Moreover, strict specifications are required for the thermal developing apparatus, resulting in a significant increase in cost.

In particular, heat developable photosensitive materials prepared by methods involving coating with an organic solvent tend to show a larger change in color tone when compared to materials prepared by aqueous coating methods. Furthermore, the positive effects obtained by employing the aforementioned improving methods are still insufficient, and further improvement has been desired.

Therefore, there is a need for a method for stably controlling a color tone of a finished image of a heat developable photosensitive material. Moreover, there is a need for a heat developable photosensitive material capable of providing an image color tone in which unwanted changes due to variances in thermal developing temperature or time are minimized, thereby providing a constantly stable finished image.

### SUMMARY OF THE INVENTION

The invention provides a heat developable photosensitive material including a substrate having provided thereon at least one constituent layer, which contains a photosensitive silver halide, a non-photosensitive organic silver salt, a reducing agent for thermal developing and a binder, wherein at least one reducing agent that does not form a dye at the time of thermal developing and at least one reducing agent forming a dye at the time of thermal developing that is more active than said at least one reducing agent that does not form a dye at the time of thermal developing are used as said reducing agent for thermal developing.

In the case where the heat developable photosensitive material has a plurality of constituent layers, the above-mentioned components may be included in differing constituent layers.

### DETAILED DESCRIPTION OF THE INVENTION

Hereafter, the invention will be explained in detail.

Explanation Regarding Reducing Agent

The present inventors have made intensive investigations and have found that a combination of a reducing agent that does not form a dye and a reducing agent that forms a dye enable control of an image color tone. More specifically, they have found that a reducing agent of the below formula R1 does not provide a colored component in the photosensitive material, that a reducing agent of the below formula R2 provides a dye product having a yellow color, and that an image color tone can be controlled by utilizing a combination of these reducing agents. They have also found that fluctuation in color tone due to change in a developing temperature and/or time can be significantly reduced by selecting the reducing agent of formula R1 and the reducing agent of formula R2 which is more active than the reducing agent of formula R1 and using a combination thereof.

Furthermore, they have found that an image formed on the heat developable photosensitive material of the invention shows a significantly improved stability of color tone to light or heat over a prolonged time.

1) Reducing Agent Represented by Formula R1

Hereinafter, the reducing agent represented by formula R1 will be explained in detail.

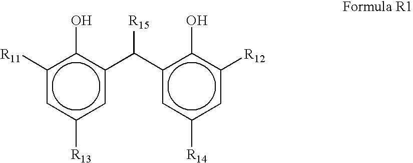

In the formula, R₁₁ and R₁₂ independently represent a primary alkyl group; R₁₃ and R₁₄ independently represent a primary alkyl group; and R₁₅ represents a hydrogen atom or an alkyl group.

Each of R₁₁ and R₁₂ represents a primary alkyl group preferably with 1 to 20 carbon atoms, more preferably with 1 to 10 carbon atoms, and still more preferably with 1 to 6 carbon atoms. Specific examples thereof include a methyl group, an ethyl group, a propyl group, a butyl group and an amyl group. These alkyl groups may have a substituent. The substituent of the substituted alkyl group is not particularly limited, but typical examples thereof include an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group and a halogen atom.

Each of R₁₃ and R₁₄ represents a primary alkyl group preferably with 1 to 20 carbon atoms, more preferably with 1 to 10 carbon atoms, and still more preferably with 1 to 6 carbon atoms. Specific examples thereof include a methyl group, an ethyl group, a propyl group, a butyl group and an amyl group. These alkyl groups may have a substituent, and the substituent of the substituted alkyl group may be similar to that of the substituted alkyl group represented by R₁₁.

R₁₅ is preferably an alkyl group with 1 to 15 carbon atoms, and specific examples thereof include a methyl group, an ethyl group, a propyl group, a butyl group, a heptyl group, an undecyl group, an isopropyl group, a 1-ethylpentyl group, a 2,4,4-trimethylpentyl group, a methoxymethyl group, a methoxypropyl group, a butoxyethyl group, a 2-acetylaminoethyl group, a 2-phenylthioethyl group, and a 2-dodecylthioethyl group. More preferably, it is an alkyl group with 1 to 5 carbon atoms, such as a methyl group, an ethyl group, a propyl group, a butyl group, an isopropyl group or an isobutyl group. Among them, a methyl group, an ethyl group and a propyl group are preferable and a methyl group is more preferable.

The compound represented by formula R1 is a compound that does not form a yellow dye at the time of thermal developing. Hereinafter, specific examples of the reducing agent represented by formula R1 are shown, but the invention is not limited to such examples.

| Gompound | R₁₁ | R₁₂ | R₁₃ | R₁₄ | R₁₅ |
|---|---|---|---|---|---|
| R1-1 | CH₃ | CH₃ | CH₃ | CH₃ | CH₃ |
| R1-2 | CH₃ | CH₃ | CH₃ | CH₃ | C₂H₅ |
| R1-3 | CH₃ | CH₃ | CH₃ | CH₃ | n-C₃H₇ |
| R1-4 | CH₃ | CH₃ | CH₃ | CH₃ | i-C₃H₇ |
| R1-5 | CH₃ | CH₃ | CH₃ | CH₃ | sec-C₅H₁₁ |
| R1-6 | CH₃ | CH₃ | CH₃ | CH₃ | n-C₅H₁₁ |
| R1-7 | CH₃ | CH₃ | CH₃ | CH₃ | C₈H₁₇¹⁾ |
| R1-8 | CH₃ | CH₃ | C₂H₅ | C₂H₅ | CH₃ |
| R1-9 | CH₃ | CH₃ | C₂H₅ | C₂H₅ | n-C₃H₇ |
| R1-10 | CH₃ | CH₃ | C₂H₅ | C₂H₅ | i-C₃H₇ |
| R1-11 | C₂H₅ | C₂H₅ | CH₃ | CH₃ | CH₃ |
| R1-12 | C₂H₅ | C₂H₅ | CH₃ | CH₃ | n-C₃H₇ |
| R1-13 | C₂H₅ | C₂H₅ | CH₃ | CH₃ | i-C₃H₇ |
| R1-14 | C₂H₅ | C₂H₅ | C₂H₅ | C₂H₅ | CH₃ |
| R1-15 | C₂H₅ | C₂H₅ | C₂H₅ | C₂H₅ | n-C₃H₇ |
| R1-16 | C₂H₅ | C₂H₅ | C₂H₅ | C₂H₅ | i-C₃H₇ |
| R1-17 | CH₃ | CH₃ | CH₃ | CH₃ | H |
| R1-18 | CH₃ | CH₃ | C₂H₅ | C₂H₅ | H |

¹⁾C₈H₁₇: CH₂CH(CH₃)CH₂C(CH₃)₃

2) Reducing Agent Represented by Formula R2

Hereinafter, the reducing agent represented by formula R2 will be explain in detail.

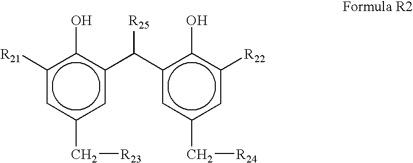

In formula R2, R₂₁ and R₂₂ independently represent a secondary or tertiary alkyl group; R₂₃ and R₂₄ independently represent a hydrogen atom, a hydroxyl group, an alkoxy group, an aryloxy group, an alkylthio group, an arylthio group, an acyloxy group, an amino group or a heterocyclic group; and R₂₅ represents an alkyl group.

Each of R₂₁ and R₂₂ represents a secondary or tertiary alkyl group preferably with 3 to 20 carbon atoms, and the alkyl group may have a substituent. The substituent of the substituted alkyl group is not particularly limited, but typical examples thereof include an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group and a halogen atom.

Each of R₂₃ and R₂₄ represents a hydrogen atom, an alkyl group with 2 to 20 carbon atoms, an alkoxy group with 1 to 20 carbon atoms, an aryloxy group with 6 to 20 carbon atoms, an alkylamino group with 2 to 20 carbon atoms, an anilino group with 6 to 20 carbon atoms, an alkylthio group with 1 to 20 carbon atoms, an arylthio group with 6 to 20 carbon atoms, an acyloxy group with 1 to 20 carbon atoms and a heterocyclic group with 3 to 20 carbon atoms, and these groups may have a substituent similar to that of the substituted alkyl group represented by R₂₁.

R₂₅ is preferably a hydrogen atom or an alkyl group with 1 to 20 carbon atoms, and the alkyl group may have a substituent similar to that of the substituted alkyl group represented by R₂₁.

Each of R₂₁ and R₂₂ is more preferably a secondary or tertiary alkyl group with 3 to 15 carbon atoms, and specific examples thereof include an isopropyl group, an isobutyl group, a t-butyl group, a t-amyl group, a t-octyl group, a cyclohexyl group, a cyclopentyl group, a 1-methylcyclohexyl group, and a 1-methylcyclopropyl group. Each of R₂₁ and R₂₂ is more preferably a tertiary alkyl group with 4 to 12 carbon atoms. Among them, a t-butyl group, and a t-amyl group are still more preferable and a t-butyl group is most preferable.

Each of R₂₃ and R₂₄ is more preferably a hydrogen atom, an alkyl group with 1 to 15 carbon atoms, a hydroxyl group, an alkoxy group, an aryloxy group or an amino group, and specific examples thereof include a hydrogen atom, a hydroxyl group, a methoxy group, an ethoxy group, a butoxy group, an octyloxy group, a methoxyethoxy group, a cyclohexyloxy group, a phenoxy group, an N,N-dimethylamino group, a N,N-dibutylamino group, an N-methylanilino group and a piperidinyl group. Among them, a hydrogen atom, a methoxy group and an N,N-dimethylamino group are still more preferable and a hydrogen atom is most preferable.

R₂₅ is more preferably a hydrogen atom or an alkyl group with 1 to 15 carbon atoms, and specific examples thereof include a hydrogen atom, a methyl group, an ethyl group, a propyl group, a butyl group, a heptyl group, an undecyl group, an isopropyl group, a 1-ethylpentyl group, a 2,4,4-trimethylpentyl group, a methoxymethyl group, a methoxypropyl group, a butoxyethyl group, a 2-acetylaminoethyl group, a 2-phenylthioethyl group, and a 2-dodecylthioethyl group. A hydrogen atom, and an alkyl group with 1 to 5 carbon atoms are still more preferable, and specific examples thereof include a hydrogen atom, a methyl group, an ethyl group, a propyl group, a butyl group, an isopropyl group and an isobutyl group. Among them, a hydrogen atom, a methyl group, an ethyl group and a propyl group are more preferable and a hydrogen atom and a methyl group are most preferable.

The reducing agent represented by formula R2 forms a yellow dye at the time of thermal developing, though formed color is somewhat variable depending on the structure of the dye. Hereafter, specific examples of the reducing agent represented by formula R2 are shown, but the invention is not limited to such examples.

| Compound | R₂₁ | R₂₂ | R₂₃ | R₂₄ | R₂₅ |
|---|---|---|---|---|---|
| R2-1 | t-C₄H₉ | t-C₄H₉ | H | H | H |
| R2-2 | t-C₄H₉ | t-C₄H₉ | H | H | CH₃ |
| R2-3 | t-C₄H₉ | t-C₄H₉ | H | H | C₂H₅ |
| R2-4 | t-C₄H₉ | t-C₄H₉ | H | H | n-C₃H₇ |
| R2-5 | t-C₄H₉ | t-C₄H₉ | H | H | i-C₃H₇ |
| R2-6 | t-C₄H₉ | t-C₄H₉ | OH | OH | H |
| R2-7 | t-C₄H₉ | t-C₄H₉ | OH | OH | C₂H₅ |
| R2-8 | t-C₄H₉ | t-C₄H₉ | OCH₃ | OCH₃ | H |
| R2-9 | t-C₄H₉ | t-C₄H₉ | OCH₃ | OCH₃ | n-C₃H₇ |
| R2-10 | t-C₄H₉ | t-C₄H₉ | OCH₂C₆H₅ | OCH₂C₆H₅ | CH₃ |
| R2-11 | t-C₄H₉ | t-C₄H₉ | OC₆H₁₃ | OC₆H₁₃ | H |
| R2-12 | t-C₄H₉ | t-C₄H₉ | OCH₂CH(CH₃)₂ | OCH₂CH(CH₃)₂ | CH₃ |
| R2-13 | t-C₄H₉ | t-C₄H₉ | N(CH₃)₂ | N(CH₃)₂ | CH₃ |
| R2-14 | t-C₃H₇ | i-C₃H₇ | SC₁₂H₂₅ | SC₁₂H₂₅ | H |
| R2-15 | t-C₅H₁₁ | t-C₅H₁₁ | OCOCH₃ | OCOCH₃ | C₂H₅ |
| R2-16 | t-C₄H₉ | t-C₄H₉ | H | H | C₂H₄OCH₃ |

| | |
|---|---|
| R2-17 | R2-18 |
| 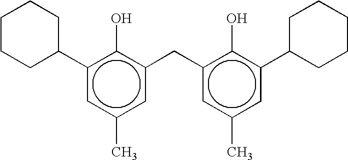 | 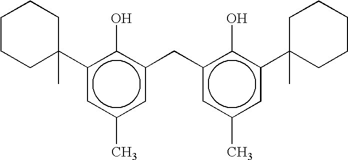 |
| R2-19 | R2-20 |
| 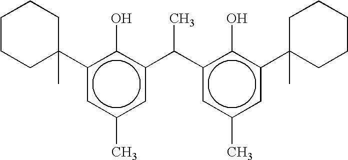 | 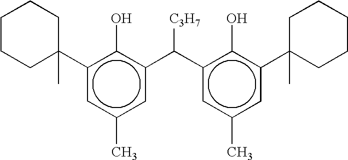 |
| R2-21 | R2-22 |
| 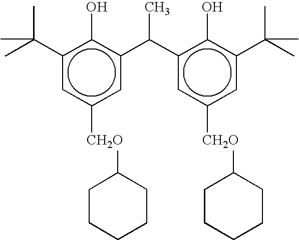 | 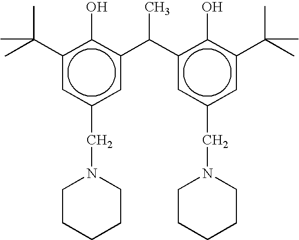 |
| R2-23 | R2-24 |
| 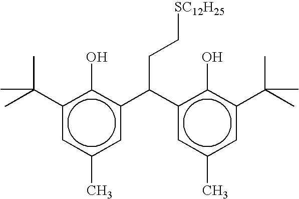 | 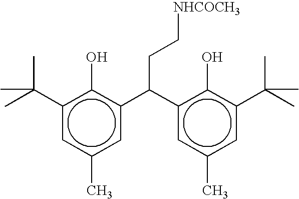 |

Other preferred examples of the reducing agents of formulae R1 and R2 include compounds matching the definition of the invention, among those described in JP-A Nos. 2001-188314, 2001-209145, 2001-350235 and 2002-156727.

In the invention, the total amount of the reducing agents of formulas R1 and R2 is preferably 0.1 to 3.0 g/m², more preferably 0.2 to 1.5 g/m² and still more preferably 0.3 to 1.0 g/m². The reducing agents are preferably contained in an amount of 5 to 50 mol % with respect to 1 mole of silver on a surface having the image forming layer, more preferably 8 to 30 mol % and still more preferably 10 to 20 mol %. The reducing agents are preferably contained in the image forming layer.

The molar amount of the reducing agent of formula R1 is preferably larger than that of the reducing agent of formula R2. The reducing agent of formula R2 is more preferably employed in an amount ranging from 5 to 40 mol % with respect to the total molar amount of the reducing agents, and still more preferably in an amount ranging from 10 to 30 mol %.

The relative relationship of developing activity of each of the reducing agents of formulae R1 and R2 can be evaluated from the relative relationship of sensitivity when the reducing agent of formula R1 is used alone in a configuration where the reducing agents of formulae R1 and R2 are to be used and sensitivity when the reducing agent of formula R2 is used alone in the configuration. More specifically, in the invention, the reducing agent A represented by formula R2 can be regarded as having higher developing activity than the reducing agent B represented by formula R1, when the reducing agent A is used alone in a photosensitive material and a logarithmic value (−log E) of an exposure amount E providing an image density of 1.5 is larger by 0.02 or more than a logarithmic value (−log E) of an exposure amount E providing an image density of 1.5 when the reducing agent B is used alone. In the invention, it is preferable that the reducing agent of formula R2 has higher relative sensitivity than the reducing agent of formula R1 by 0.03 or more, preferably 0.05 or more and more preferably 0.08 or more. It is possible to make the proportion of the reducing agent of formula R2 smaller as the difference of relative sensitivities of the reducing agents of formulae R1 and R2 increases. The proportion of the reducing agent of formula R2 is preferably 30 mol % or less when the difference is 0.05 or higher, and 20 mol % or less when the difference is 0.10 or higher.

The reducing agents of formulae R1 and R2 may be contained in a coating liquid or in a photosensitive material in any form such as a solution, an emulsified dispersion or a solid particulate dispersion.

As a well known method, a method for preparing an emulsified dispersion by dissolving a material in an auxiliary solvent, for example, an oil such as dibutyl phthalate, tricresyl phosphate, glyceryl triacetate or diethyl phthalate, ethyl acetate or cyclohexanone, and mechanically dispersing the resultant is used.

In the invention, the reducing agents are preferably used as a solution obtained by dissolving them in an organic solvent.

In the invention, known reducing agent for an organic silver salt may be employed in combination with the reducing agents of formulae R1 and R2. Examples of such a reducing agent are described in JP-A No. 11-65021, paragraphs 0043-0045, and EP No. 803,764A1, page 7, line 34 to page 18, line 12. A hindered phenol reducing agent having a substituent at an ortho-position with respect to a phenolic hydroxyl group, or a bisphenol reducing agent is particularly preferable as such.

Explanation of Photosensitive Silver Halide

1) Halogen Composition

The halogen composition of photosensitive silver halide to be employed in the invention is not particularly limited, and can be silver chloride, silver chlorobromide, silver bromide, silver iodobromide, silver chloroiodobromide, or silver iodide. Among these, silver bromide and silver iodobromide are preferable. A halogen composition distribution within each grain of the silver halide may be uniform, or may change stepwise or continuously. A silver halide grain having a core/shell structure may also be advantageously employed. A core/shell grains preferably have a 2- to 5-layered structure, and more preferably have a 2- to 4-layered structure. A method of localizing silver chloride, silver chlorobromide, silver bromide, silver iodobromide, silver chloroiodobromide or silver iodide in silver chloride, silver chlorobromide, silver bromide, silver iodobromide, silver chloroiodobromide or silver iodide can also be advantageously employed.

2) Grain Size

It is not preferable to use photosensitive silver halide grains having a large size in the invention, since transparency of the film after image formation become insufficient. The size of silver halide grains is preferably 0.20 μm or less, more preferably 0.01 to 0.15 μm and still more preferably 0.02 to 0.12 μm. In the invention, the grain size means the average of diameters of circles each having the same area as the projected area of each grain (the projected area of a principal plane in the case of a tabular grain) obtained by electron microscopic observation.

3) Coating Amount

The coating amount (silver amount) of such silver halide grains is 0.03 to 0.6 g/m², preferably 0.05 to 0.4 g/m², and more preferably 0.07 to 0.3 g/m². It is within a range of 0.01 to 0.5 moles with respect to 1 mole of silver of a non-photosensitive organic silver salt to be explained later, preferably 0.02 to 0.3 moles and still more preferably 0.03 to 0.2 moles.

4) Grain Forming Method

A method for forming photosensitive silver halide is well known in the related art, and, for example, methods described in Research Disclosure 17029, June 1978 and U.S. Pat. No. 3,700,458 can be utilized as such. More specifically, a method of adding a silver supplying compound and a halogen supplying compound to a solution of gelatin or another polymer to prepare photosensitive silver halide, and thereafter mixing the photosensitive silver halide with an organic silver salt is employed. A method described in JP-A No. 11-119374, paragraphs 0217 to 0224, and methods described in JP-A No. 11-352627 and JP-A No. 2000-347335 are also preferably employed.

For example, a so-called halidation method in which a part of silver of an organic silver salt is halogenated with an organic or inorganic halide can also be advantageously employed. In this method, any organic halide that can react with the organic silver salt to generate silver halide can be employed, and examples thereof include an N-halogenoimide (such as N-bromosuccinimide), a quaternary nitrogen compound halide (such as tetrabutylammonium bromide), and an aggregate of a quaternay nitrogen compound halide and a halogen molecule (such as bromopyridinium perbromide). Any inorganic halide that can react with the organic silver salt to generate silver halide can also be employed, and examples thereof include an alkali metal halide and an ammonium halide (such as sodium chloride, lithium bromide, potassium iodide or ammonium bromide), an alkaline earth metal halide (such as calcium bromide or magnesium chloride), a transition metal halide (such as ferric chloride or cupric bromide), a metal complex having a halogen ligand (such as sodium bromoiridate, or ammonium chlororhodate), and a halogen molecule (such as bromine, chlorine or iodine). Desired organic or inorganic halide compounds may also be employed in combination. The amount of the halide (the amount of halogen molecules) at the time of halidation is preferably 1 to 500 mmol per 1 mole of the organic silver salt, and more preferably 10 to 250 mmol.

The photosensitive silver halide grains may be desalted by washing with water in a method known in the art, such as a noodle method or a flocculation method, but the desalting may not be conducted in the invention.

5) Grain Shape

The shape of silver halide grains can be cubic, octahedral, tetradecahedral, dodecahedral, tabular, spherical, rod-like, or potato-like, and dodecahedral, tetradecahedral and tabular grains are preferable in the invention. The silver halide grains having a composition with a high silver iodide content can have a complex shape, but a jointed grain, as described by R. L. Jenkins et al., J. of Phot. Sci., Vol. 28 (1980), p. 164-FIG. 1, and the like is preferable. Tabular grains as shown in FIG. 1 can also be advantageously employed. Grains whose corners are rounded can also be advantageously employed. The plane index (Miller's index) of an external surface of the photosensitive silver halide grains is not particularly restricted, but it is preferable that a [100] plane, showing a high spectral sensitization efficiency when a spectral sensitizing dye is adsorbed, has a high proportion. The proportion is preferably 50% or higher, more preferably 65% or higher and still more preferably 80% or higher. The proportion of the Miller index [100] plane can be determined by a method described in T. Tani; J. Imaging Sci., 29, 165 (1985), utilizing adsorption dependences of [111] and [100] planes in adsorption of a sensitizing dye.

6) Heavy Metal

The photosensitive silver halide grains may include a metal or a metal complex of groups 8 to 10 of the periodic table (including groups 1 to 18). The metal or the central metal of the metal complex belonging to the groups 8 to 10 of the periodic table is preferably rhodium, or ruthenium. Such a metal complex may be used alone or at least two complexes of a same metal or different metals can be used in combination. The content thereof is preferably within a range of 1×10⁻⁹ to 1×10⁻³ moles per 1 mole of silver. These heavy metals, complexes thereof and a method of addition thereof are described in JP-A Nos. 7-225449, 11-65021, paragraphs 0018 to 0024, and 11-119374, paragraphs 0227 to 0240.

In the invention, silver halide grains in which hexacyano-metal complex exists at the outermost surface of the grains are preferable. Examples of the hexacyano-metal complex includes [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano iron complex is preferable.

A counter cation is not important since the hexacyano-metal complex exists in the form of an ion in an aqueous solution, but it is preferable to employ as the counter cation an ion that is easily miscible with water and is adapted to a precipitating operation of silver halide emulsion, for example an alkali metal ion such as sodium ion, potassium ion, rubidium ion, cesium ion or lithium ion, an ammonium ion or an alkylammonium ion (such as tetrtamethylammonium ion, tetraethylammonium ion, tetrapropylammonium ion or tetra(n-butyl)ammonium ion).

The hexacyano-metal complex can be added to the photosensitive silver halide by mixing it with water, or a mixed solvent of water and a suitable water-miscible organic solvent (for example an alcohol, an ether, a glycol, a ketone, an ester or an amide), or gelatin and then adding the resultant solution to the silver halide.

The amount of hexacyano-metal complex is preferably 1×10⁻⁵ to 1×10⁻² moles per 1 mole of silver, and more preferably 1×10⁻⁴ to 1×10^{31 3} moles.

In order for the hexacyano-metal complex to exist on the outermost surface of silver halide grains, the hexacyano-metal complex is directly added to a system within a period from the end of addition of aqueous silver nitrate solution for grain formation to just before initiation of a chemical sensitization step including a chalcogen sensitization such as a sulfur sensitization, selenium sensitization or tellurium sensitization, and a precious metal sensitization such as gold sensitization. More specifically, the hexacyano-metal complex can be added to the system before the end of a charging step, during a rinsing step or a dispersing step, or before a chemical sensitization step. In order to prevent growth of the silver halide fine grains, it is preferable to promptly add the hexacyano-metal complex after the grain formation in order to execute the addition before the end of the charging step.

The addition of the hexacyano-metal complex may be started after 96 mass %, preferably 98 mass % and more preferably 99 mass % of the total silver nitrate for grain formation is added.

When such a hexacyano-metal complex is added after addition of aqueous silver nitrate solution but immediately before completion of grain formation, it can be adsorbed on the outermost surface of silver halide grains, and mostly forms a low-soluble salt with silver ions on the surface of the grains. Such a silver salt of hexacyano iron (II) is less soluble than AgI, and it is possible to avoid redissolution of fine grains, thereby enabling production of fine silver halide grains having a small grain size.

Other metal atoms that can be included in the silver halide grains to be employed in the invention, and a desalting method and a chemical sensitizing method of the silver halide emulsion are described in JP-A Nos. 11-84574, paragraphs 0046-0050, 11-65021, paragraphs 0025-0031, and 11-119374, paragraphs 0242-0250.

7) Gelatin

Any gelatin can be contained in the photosensitive silver halide emulsion to be employed in the invention. In order to maintain a satisfactory dispersion state of the photosensitive silver halide emulsion in a coating liquid containing an organic silver salt, it is preferable to use a low molecular gelatin having a molecular weight of 10,000 to 1,000,000. Phthalated gelatin can also be advantageously employed. Such gelatin may be used at the time of grain formation or dispersion after desalting process, but is preferably used at the time of grain formation.

8) Chemical Sensitization

The photosensitive silver halide grains to be employed in the invention are preferably subjected to a chemical sensitization by sulfur sensitization, selenium sensitization or tellurium sensitization. A compound employed in the sulfur sensitization, the selenium sensitization or the tellurium sensitization can be a known compound, such as one described in JP-A No. 7-128768. In the invention, the tellurium sensitization is particularly preferable, and compounds disclosed in references described in JP-A No. 11-65021, paragraph 0030, or compounds represented by formulas (II), (III) and (IV) in JP-A No. 5-313284 are preferable.

The amount of a sulfur, selenium or tellurium sensitizer to be employed in the invention depends on the silver halide grains to be employed, and/of chemical ripening conditions, but is in a range of about 10⁻⁸ to 10⁻² moles with respect to 1 mole of silver halide, and preferably 10⁻⁷ to 10⁻³ moles.

The photosensitive silver halide grains of the invention may be chemically sensitized by a gold sensitization method in combination with the aforementioned chalcogen sensitization. A gold sensitizer having monovalent or trivalent gold is preferable. Typical examples of the gold sensitizer include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyl trichlorogold. In addition, gold sensitizers described in U.S. Pat. No. 5,858,637 and JP-A No. 2002-278016 may also be advantageously employed.

The addition amount of the gold sensitizer to be used depends on various conditions, but is generally in a range from 10⁻⁷ to 10⁻³ moles with respect to 1 mole of silver halide, and preferably 10⁻⁶ to 5×10⁻⁴ moles.

In the invention, the chemical sensitization may be executed at any time after grain formation and before coating, and can be executed, after desalting, (1) before spectral sensitization, (2) simultaneously with spectral sensitization, (3) after spectral sensitization, or (4) immediately before coating.

Conditions of the chemical sensitization in the invention are not particularly restricted. However, generally, the pH value is 5 to 8, the pAg value is 6 to 11 and the temperature is 40 to 95° C.

A thiosulfonic acid compound may be added to the silver halide emulsion to be employed in the invention by a method described in EP No. 293,917.

The photosensitive silver halide grains to be employed in the invention may be subjected to a reduction sensitization. A reduction sensitizer is preferably ascorbic acid, thiourea dioxide, stannous chloride, aminoiminomethane sulfonic acid, a hydrazine derivative, a borane compound, a silane compound, or a polyamine compound. The reduction sensitizer may be added in any step of the photosensitive emulsion preparing process from a crystal growing step to an adjusting step just before coating. It is also preferable to conduct reduction sensitization by ripening the emulsion at a pH value of 7 or higher and at a pAg value of 8.3 or lower, or by introducing a single addition part of silver ions in the course of grain formation.

The photosensitive silver halide emulsion of the invention preferably includes an FED sensitizer (fragmentable electron donating sensitizer) as a compound for generating two electrons by a photon. The FED sensitizer is preferably a compound described in U.S. Pat. Nos. 5,747,235, 5,747,236, 6,054,260 and 5,994,051 and JP-A No. 2002-287293. The FED sensitizer may be added in any step of the photosensitive emulsion preparing process from a crystal growing step to an adjusting step just before coating. The amount of the FED sensitizer depends on various conditions, but is preferably within a range of 10⁻⁷ to 10⁻¹ mole per 1 mole of silver halide, and preferably 10⁻⁶ to 5×10⁻² moles.

9) Combined Use of Silver Halides

The photosensitive silver halide emulsion in the heat developable photosensitive material of the invention may be used alone or in combination of two or more types (for example, those having a different average grain size, different halogen composition, different crystalline tendency, or different chemical sensitizing conditions). A gradation may be regulated by employing photosensitive silver halides having a different sensitivity. Technologies relating thereto are described in, for example, JP-A Nos. 57-119341, 53-106125, 47-3929, 48-55730, 46-5187, 50-73627 and 57-150841. The photosensitive silver halide emulsions preferably have a difference in sensitivity which is 0.2 log E or larger.

10) Mixing of Silver Halide and Organic Silver Salt

The photosensitive silver halide grains can be prepared by a conversion method as explained above, but it is particularly preferable that the photosensitive silver halide grains are formed and chemically sensitized without the non-photosensitive organic silver salt.

The organic silver salt is prepared by adding an alkali metal salt (such as sodium hydroxide, or potassium hydroxide) to an organic acid to convert at least a part of the organic acid into an alkali metal soap of the organic acid, and then by adding a water-soluble silver salt (such as silver nitrate) to the resultant system, and the photosensitive silver halide may be added to the system in any stage. There are four principal mixing processes: A) a process of adding silver halide in advance to an organic acid, then adding an alkali metal salt to the resultant mixture and further adding a water-soluble silver salt to the mixture; B) a process of at first preparing an alkali metal soap of an organic acid, then mixing silver halide with the soap and adding a water-soluble silver salt to the resultant mixture; C) a proces of at first preparing an alkali metal soap of an organic acid, then converting a part thereof into a silver salt, adding silver halide to the system and converting the remainder into a silver salt; and D) a process of at first preparing an organic silver salt, and mixing silver halide with the organic silver salt. Among these, process B) or C) is preferable.

The organic silver salt containing silver halide is preferably employed as fine particles. In order to disperse the organic silver salt as fine particles, a high-speed agitator, a ball mill, a sand mill, a colloid mill, a vibration mill or a high-pressure homogenizer may be employed.

11) Addition of Silver Halide to System so as to Prepare Coating Liquid

The silver halide is preferably added to the system to prepare a coating liquid for forming an image forming layer, during a period starting from 180 minutes before coating and ending immediately before coating, preferably during a period starting from 60 minutes to 10 seconds before coating, but a mixing method and mixing conditions are not particularly restricted as long as the effect of the invention can be sufficiently exhibited. Specific examples of the mixing method include a mixing method in which mixing is conducted in a tank so as to obtain a desired average residence period calculated from a flow rate of addition and the amount of a liquid supplied to a coater, and a method using a static mixer described in, for example, N. Harnby and M. F. Edwards, “A. W. Nienow” “Liquid mixing technology”, translated by Koji Takahashi and published by Nikkan Kogyo Shimbun, 1989, Chapter 8.

Explanation Regarding Spectral Sensitizing Dye

The heat developable photosensitive material of the invention is preferably sensitized with a spectral sensitizing dye. It is preferably spectrally sensitized in a wavelength region of 700 to 1400 nm, and particularly preferably spectrally sensitized so as to have a sensitivity maximum in a near infrared region of 750 to 900 nm.

The heat developable photosensitive material of the invention can contain any spectral sensitizing dye having a maximum spectral sensitization peak in the above-mentioned range, and the sensitizing dye is preferably at least one selected from the following formulas 3a to 3d. Hereinafter, the spectral sensitizing dye (also called infrared sensitive dye) represented by formulas 3a to 3d will be explained in detail.

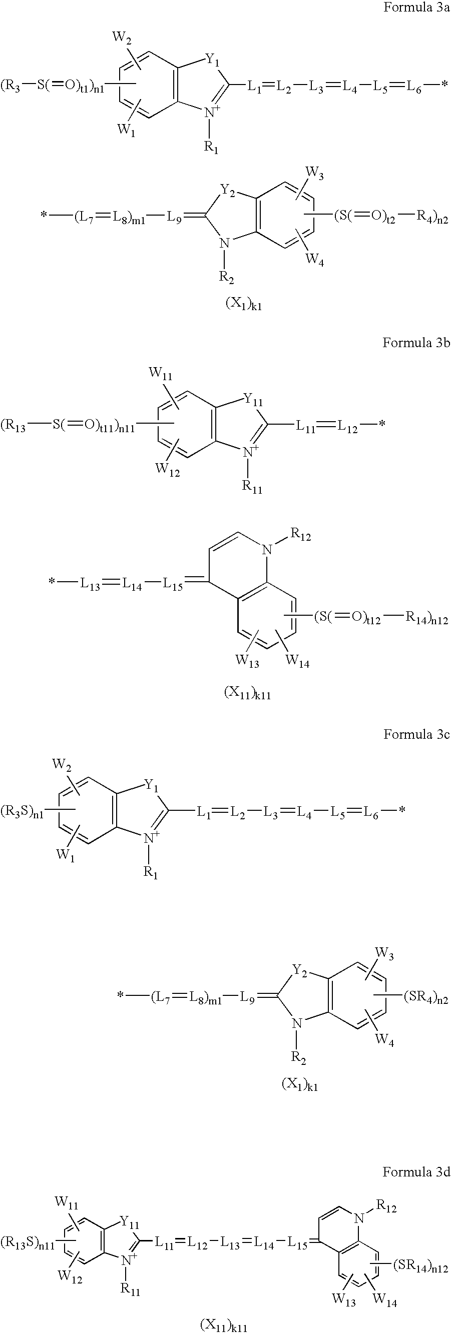

In formulas 3a to 3d, Y₁, Y₂ and Y₁₁ independently represent a chalcogen atom including an oxygen atom, a sulfur atom, a selenium atom or a —CH═CH— group; R₁, R₂, R₁₁ and R₁₂ independently represent an aliphatic group, which can be a branched or linear alkyl group with 1 to 10 carbon atoms (such as a methyl group, an ethyl group, a propyl group, a butyl group, a pentyl group, an iso-pentyl group, a 2-ethyl-hexyl group, an octyl group or a decyl), an alkenyl group with 3 to 10 carbon atoms (such as a 2-propenyl group, a 3-butenyl group, a 1-methyl-3-propenyl group, a 3-pentenyl group, a 1-methyl-3-butenyl group or a 4-hexenyl group), or an aralkyl group with 7 to 10 carbon atoms (such as a benzyl group or a phenethyl group). The above-described group may be further substituted with a group, which can be a lower alkyl group (such as a methyl group, an ethyl group or a propyl group), a halogen atom (such as a fluorine atom, a chlorine atom or a bromine atom), a vinyl group, an aryl group (such as a phenyl group, a p-tolyl group, a p-bromophenyl group or a carboxyphenyl group), a trifluoromethyl group, an alkoxy group (such as a methoxy group, an ethoxy group or a methoxyethoxy group), an aryloxy group (such as a phenoxy group or a p-tolyloxy group), a cyano group, a sulfonyl group (such as a methanesulfonyl group, a trifluoromethanesulfonyl group or p-toluenesulfonyl group), an alkoxycarbonyl group (such as an ethoxycarbonyl group or a butoxycarbonyl group), an amino group (such as an amino group, a biscarboxymethylamino group), a heterocyclic group (such as a tetrahydrofurfuryl group or a 2-pyrrolidinon-1-yl group), an acyl group (such as an acetyl group or a benzoyl group), an ureido group (such as an ureido group, a 3-methylureido group or a 3-phenylureido group), a thioureido group (such as a thioureido group or a 3-methylthioureido group), an alkylthio group (such as a methylthio group or an ethylthio group), an arylthio group (such as a phenylthio group), a heterocyclic thio group (such as a 2-thienylthio group, a 3-thienylthio group or a 2-imidazolylthio group), a carbonyloxy group (such as an acetyloxy group, a propanoyloxy group or a benzoyloxy group), an acylamino group (such as an acetylamino group or a benzoylamino group), or a thioamide group (such as a thioacetamide group, or a thiobenzoylamino group); or with a hydrophilic group, which can be a sulfo group, a carboxy group, a phosphono group, a sulfate group, a hydroxyl group, a mercapto group, a sulfino group, a carbamoyl group (such as a carbamoyl group, an N-methylcarbamoyl group, an N,N-tetramethylenecarbamoyl group), a sulfamoyl group (such as a sulfamoyl group, or an N,N-3-oxapentamethyleneaminosulfonyl group), a sulfonamide group (such as a methanesulfonamide group or a butanesulfonamide group), a sulfonylaminocarbonyl group (such as a methanesulfonylaminocarbonyl group or an ethanesulfonylaminocarbonyl group), an acylaminosulfonyl group (such as an acetamidesulfonyl group or a methoxyacetamidesulfonyl group), an acylaminocarbonyl group (such as an acetamidecarbonyl group or a methoxyacetamidecarbonyl group), or a sulfinylaminocarbonyl group (such as a methanesulfinylaminocarbonyl group or an ethanesulfinylaminocarbonyl group).

Specific examples of the aliphatic group substituted with such a hydrophilic group include a carboxymethyl group, a carboxyethyl group, a carboxybutyl group, a carboxypentyl group, a 3-sulfatebutyl group, a 3-sulfopropyl group, a 2-hydroxy-3-sulfopropyl group, a 4-sulfobutyl group, a 5-sulfopentyl group, a 3-sulfopentyl group, a 3-sulfinobutyl group, a 3-phosphonopropyl group, a hydroxyethyl group, an N-methanesulfonylcarbamoylmethyl group, a 2-carboxy-2-propenyl group, an o-sulfobenzyl group, a p-sulfophenethyl group and a p-carboxybenzyl group.

R₃, R₄, R₁₃ and R₁₄ independently represent a lower alkyl group, for example a linear or branched alkyl group with 5 or less carbon atoms, such as a methyl group, an ethyl group, a propyl group, a butyl group, a pentyl group or an isopropyl group; a cycloalkyl group such as a cyclopropyl group, a cyclobutyl group or a cyclopentyl group; an alkenyl group such as a 2-propenyl group, a 3-butenyl group, 1-methyl-3-propenyl group, a 3-pentenyl group, a 1-methyl-3-butenyl group or a 4-hexenyl group; an aralkyl group such as a benzyl group, a phenethyl group, a p-methoxyphenylmethyl group or an o-acetylaminophenylethyl group; an aryl group which may be unsubstituted or substituted such as a phenyl group, a 2-naphthyl group, a 1-naphthyl group, a o-tolyl group, an o-methoxyphenyl group, a m-chlorophenyl group, a m-bromophenyl group, a p-tolyl group or a p-ethoxyphenyl group; or a heterocyclic group which may be unsubstituted or substituted such as a 2-furyl group, 5-methyl-2-furyl group, a 2-thienyl group, a 3-thienyl group, a 2-imidazolyl group, a 2-methyl-1-imidazolyl group, a 4-phenyl-2-thiazolyl group, a 5-hydroxy-2-benzothiazolyl group, a 2-pyridyl group or a 1-pyrrolyl group.

Each of these groups may be substituted with a lower alkyl group (such as a methyl group or an ethyl group), a lower alkoxy group (such as a methoxy group or an ethoxy group), a hydroxyl group, a halogen atom (such as a fluorine atom, a chlorine atom, a bromine atom or an iodine atom), an aryl group (such as a phenyl group, a tolyl group or a chlorophenyl group), a mercapto group, or a lower alkylthio group (such as a methylthio group or an ethylthio group).

W₁ to W₄ and W₁₁ to W₁₄ independently represent an alkyl group (such as a methyl group, an ethyl group, a butyl group or an isobutyl group), an aryl group (including a monocyclic group and a polycyclic group, such as a phenyl group or a naphthyl group), a heterocyclic group (such as a thienyl group, a furyl group, a pyridyl group, a carbazolyl group, a pyrrolyl group, or an indolyl group), a halogen atom (such as a fluorine atom, a chlorine atom or a bromine atom), a vinyl group, an aryl group (such as a phenyl group, a p-tolyl group, a p-bromophenyl group or a carboxyphenyl group), a trifluoromethyl group, an alkoxy group (such as a methoxy group, an ethoxy group or a methoxyethoxy group), an aryloxy group (such as a phenoxy group or a p-tolyloxy group), a sulfonyl group (such as a methanesulfonyl group or a p-toluenesulfonyl group), an alkoxycarbonyl group (such as an ethoxycarbonyl group or a butoxycarbonyl group), an amino group (such as an amino group, or a biscarboxymethylamino group), a heterocyclic group (such as a tetrahydrofurfuryl group or a 2-pyrrolidinon-1-yl group), an acyl group (such as an acetyl group, or a benzoyl group), an ureido group (such as an ureido group, a 3-methylureido group or a 3-phenylureido group), a thioureido group (such as a thioureido group or a 3-methylthioureido group), an alkylthio group (such as a methylthio group or an ethylthio group), an arylthio group (such as a phenylthio group), a hydroxyl group or a styryl group.

Each of these groups may be substituted with a group cited in the explanation of the aliphatic group represented by R₁ and the like, and specific examples of a substituted alkyl group include a 2-methoxyethyl group, a 2-hydroxyethyl group, a 3-ethoxycarbonylpropyl group, a 2-carbamoylethyl group, a 2-methanesulfonylethyl, a 3-methanesulfonylaminopropyl group, a benzyl group, a phenethyl group, a carboxymethyl group, a carboxyethyl group,. an allyl group and a 2-furylethyl group. Also specific examples of a substituted aryl group include a p-carboxyphenyl group, a p-N,N-dimethylaminophenyl group, a p-morpholinophenyl group, a p-methoxyphenyl group, a 3,4-dimethoxyphenyl group, a 3,4-methylenedioxyphenyl group, a 3-chlorophenyl group and a p-nitrophenyl group. Also specific examples of a substituted heterocyclic group include a 5-chloro-2-pyridyl group, a 5-ethoxycarbonyl-2-pyridyl group and a 5-carbamoyl-2-pyridyl group.

A condensed ring, such as a 5-membered or 6-membered saturated or unsaturated carbon-containing ring, may be formed by mutual bonding of W₁ and W₂, W₃ and W₄, W₁₁ and W₁₂, W₁₃ and W₁₄, R₃ and W₁, R₃ and W₂, R₁₃ and W₁₁, R₁₃ and W₁₂, R₄ and W₃, R₄ and W₄, R₁₄ and W₁₃, or R₁₄ and W₁₄. Such a condensed ring may have a substituent at an arbitrary position, and examples of the substituent are the same as examples of the substituent of the aforementioned aliphatic group.

In formulas 3a to 3d, L₁ to L₉ and L₁₁ to L₁₅ each independently represent a substituted or unsubstituted methine group. Specific examples of the substituent include a substituted or unsubstituted lower alkyl group (such as a methyl group, an ethyl group, an isopropyl group or a benzyl group), an alkoxy group (such as a methoxy group, or an ethoxy group), an aryloxy group (such as a phenoxy group or a naphthoxy group), an aryl group (such as a phenyl group, a naphthyl group, a p-tolyl group or an o-carboxyphenyl group), —N(V₁, V₂), —SR or a heterocyclic group (such as a 2-thienyl group, a 2-furyl group or an N,N′-bis(methoxyethyl) barbiturate group, wherein R represents a lower alkyl group, an aryl group or a heterocyclic group as mentioned above; V₁ and V₂ each represent a lower alkyl group or an aryl group, which may be substituted or unsubstituted; and V₁ and V₂ may bond to each other to form a 5- or 6-membered nitrogen-containing heterocyclic ring. Also, each methine group may be bonded to an immediately adjacent methine group or to a methine group separated by a methine group therebetween, to form a 5- or 6-membered ring.

When the compounds represented by formulas 3a to 3d have as a substituent a group having a cationic or anionic charge, the compounds also have a counter ion which is an equivalent amount of an anion or a cation, so as to cancel the charge in the molecule. When an ion represented by X₁ or X₁₁ and required to cancel the charge in the molecule is a cation, specific examples of the cation include a proton, an organic ammonium ion (such as a triethylammonium ion or a triethanolammonium ion), and an inorganic cation (such as a cation of lithium, sodium or potassium). When the ion represented by X₁ or X₁₁ and required to cancel the charge in the molecule is an acid anion, specific examples of the acid anion include a halogen ion (such as a chlorine ion, a bromine ion or an iodine ion), a p-toluenesulfonate ion, a perchlorate ion, a boron tetrafluoride ion, a sulfate ion, a methylsulfate ion, an ethylsulfate ion, a methanesulfonate ion and a trifluoromethanesulfonate ion.

In formulas 3a to 3d, t1, t2, t11 and t12 independently represent an integer of 0, 1 or 2, and are preferably 0 or 1, and are more preferably 1. n₁, n₂, n₁₁ and n₁₂ independently represent 0, 1 or 2. It is preferable that one of n₁ and n₂ and one of n₁₁ and n₁₂ are 1. It is more preferable that both of n₁ and n₂ and both of n₁₁ and n₁₂ are 1. Y₁, Y₂ and Y₁₁ preferably represent a sulfur atom or a selenium atom, and more preferably represent a sulfur atom. m₁ represents 0 or 1 and is preferably 1. k₁ and k₁₁ independently represent a number of ions required for canceling a change in a molecule.

Specific examples of the photosensitive dye represented by formulas 3a to 3d are shown below, but the invention is not limited to such examples.

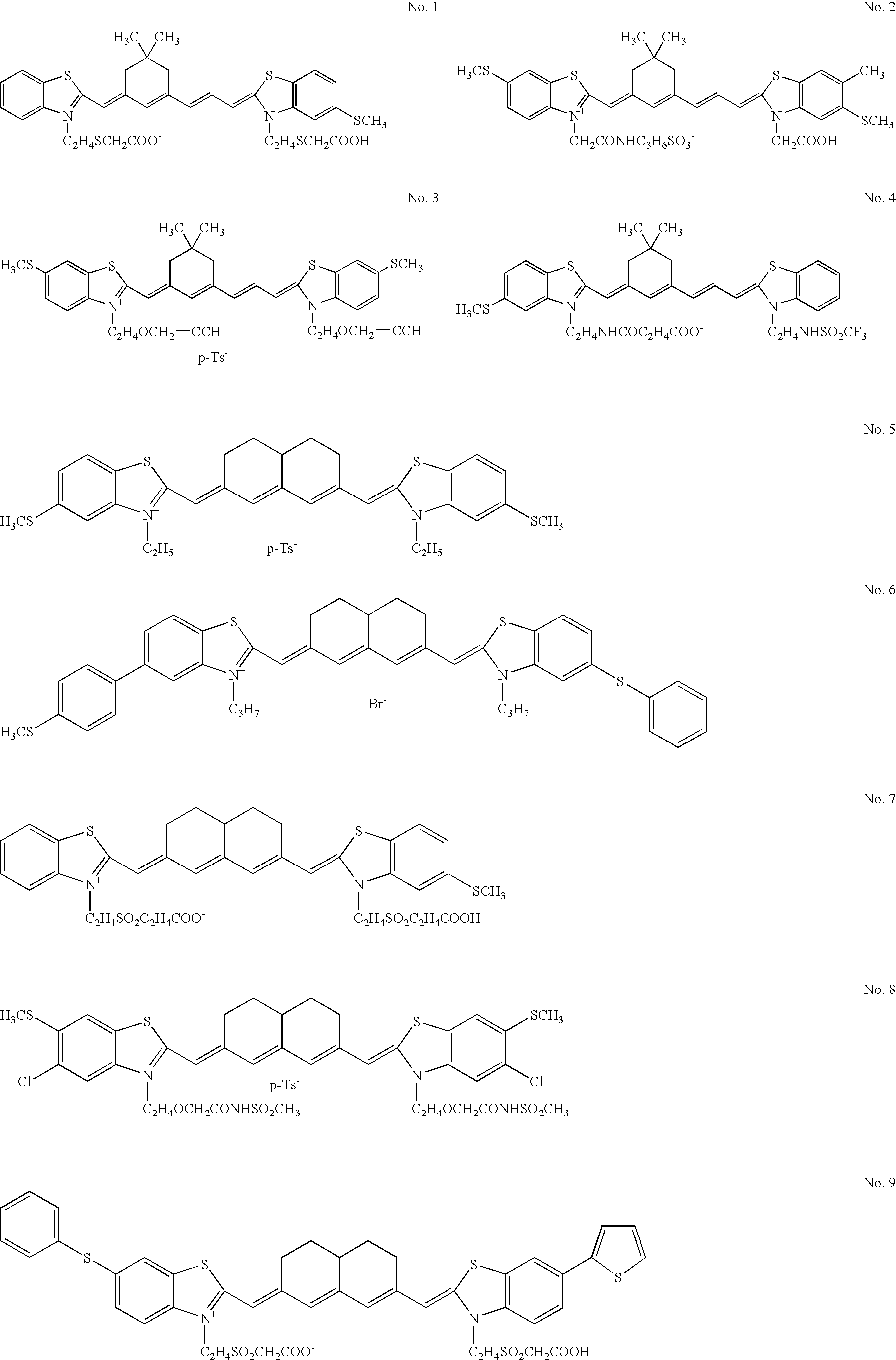

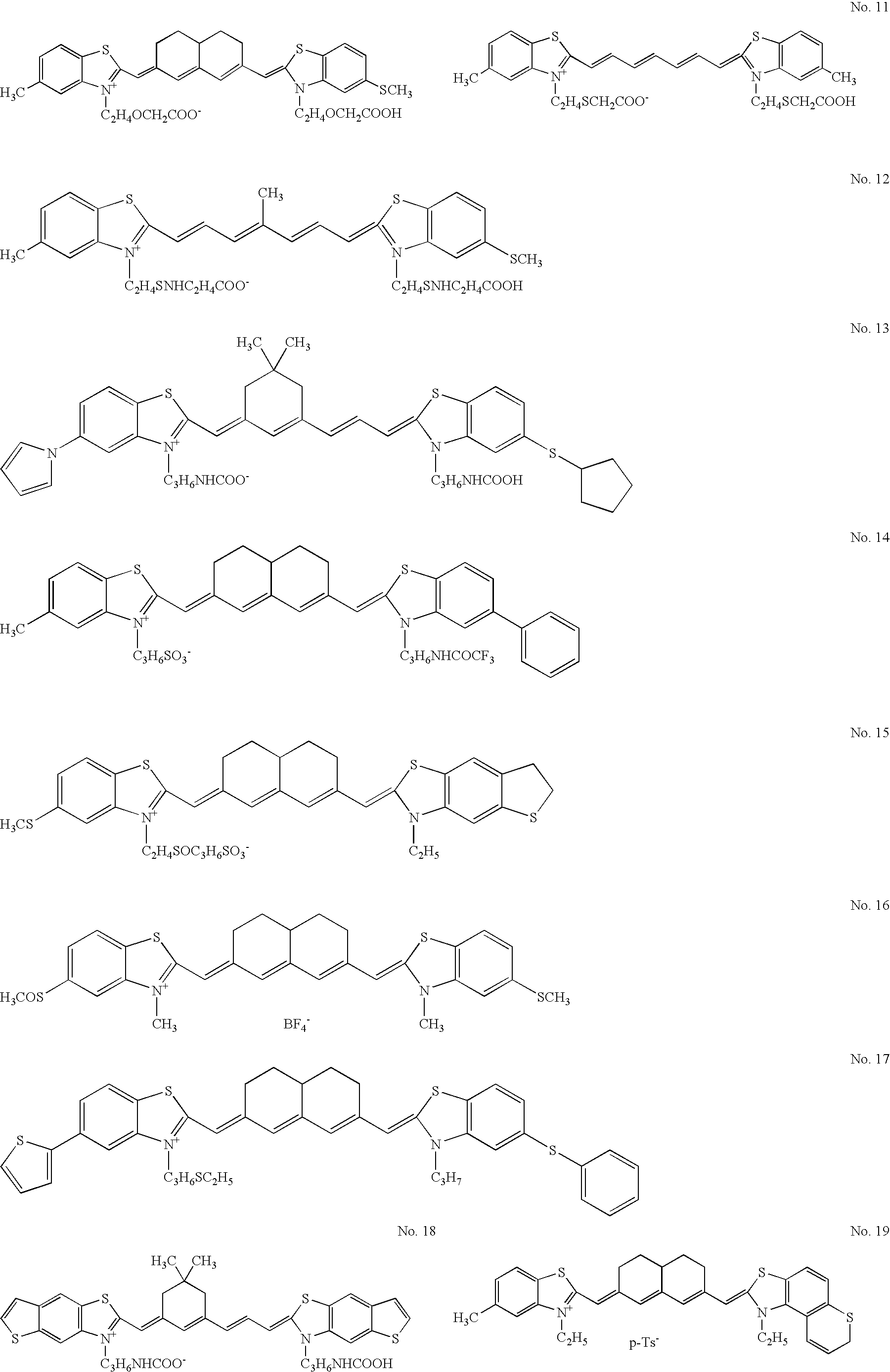

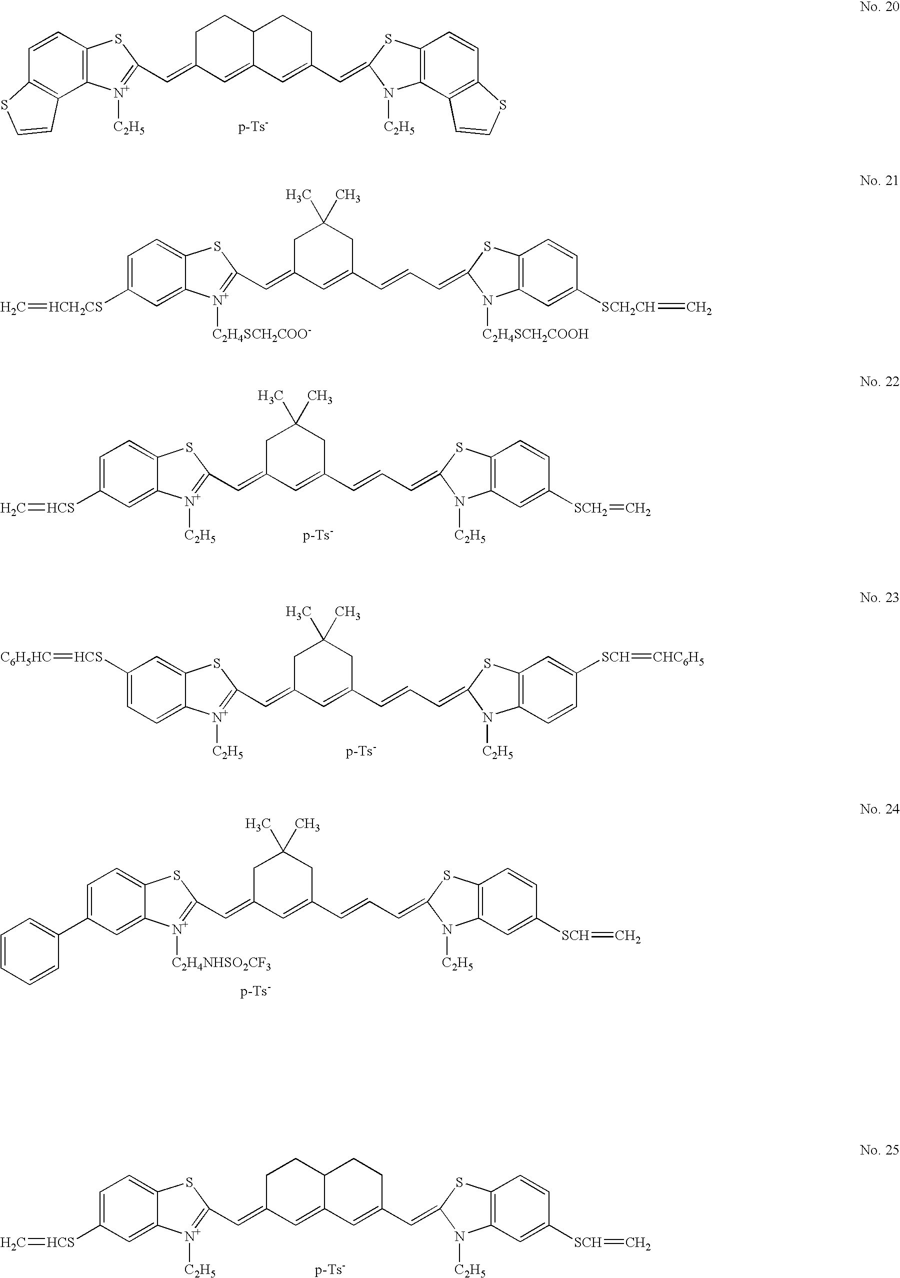

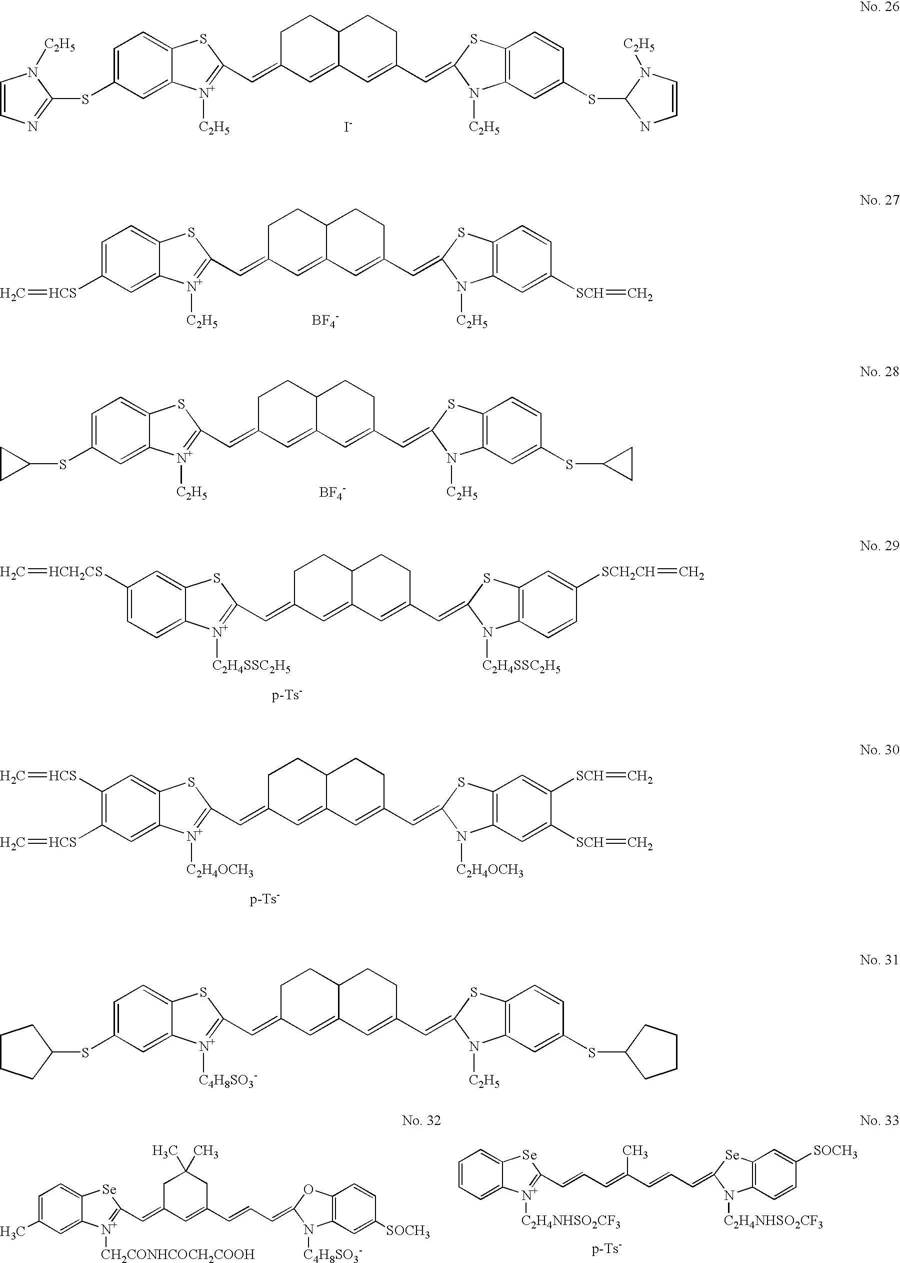

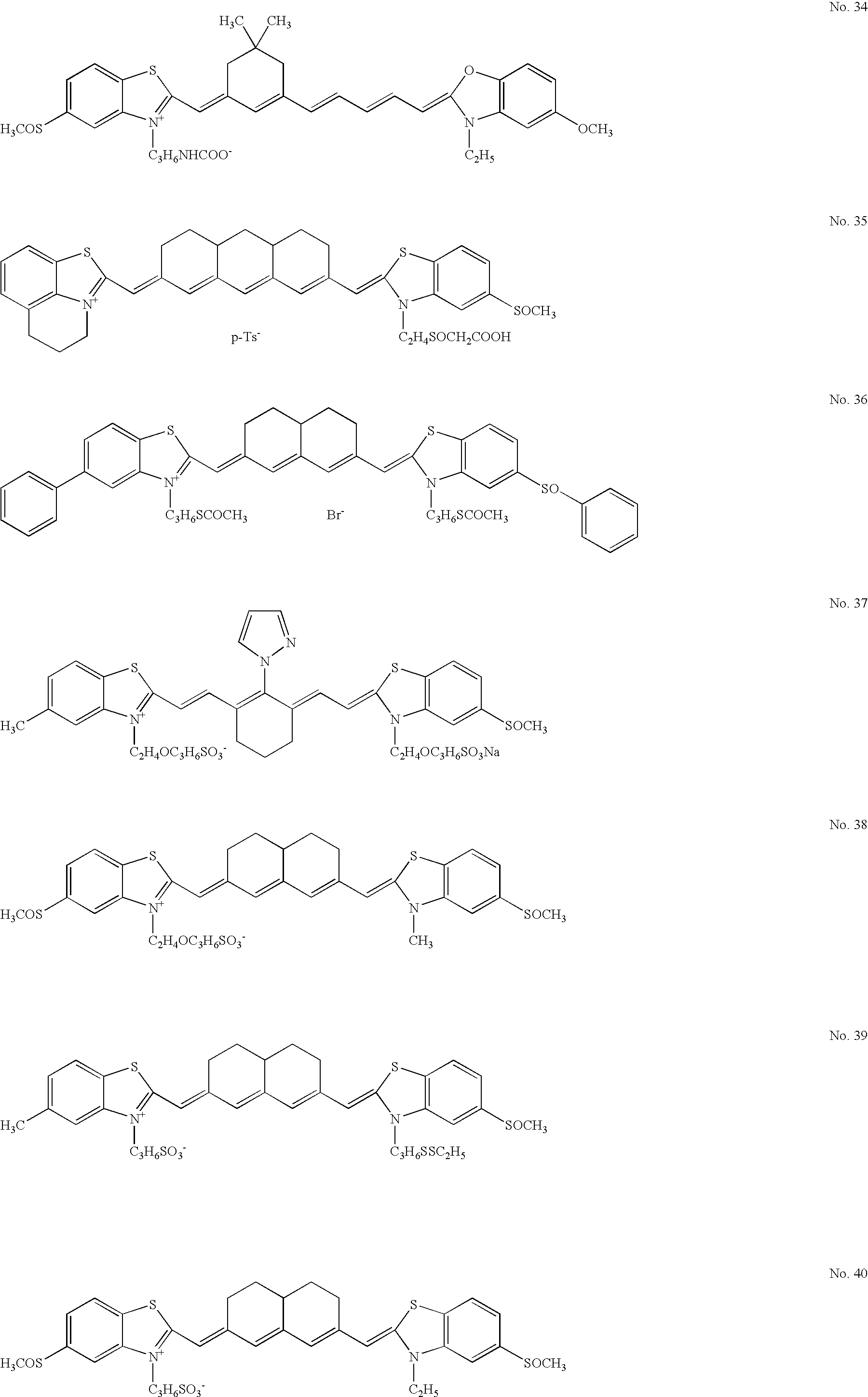

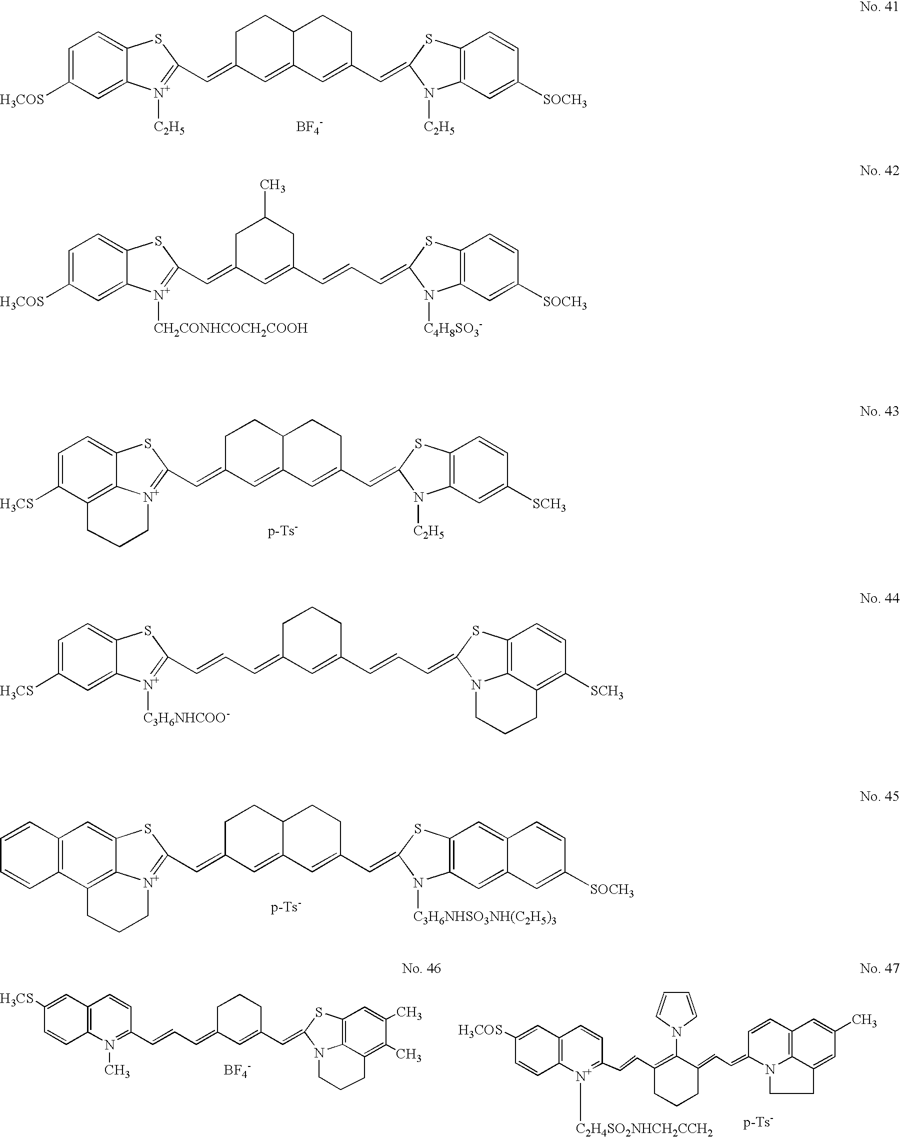

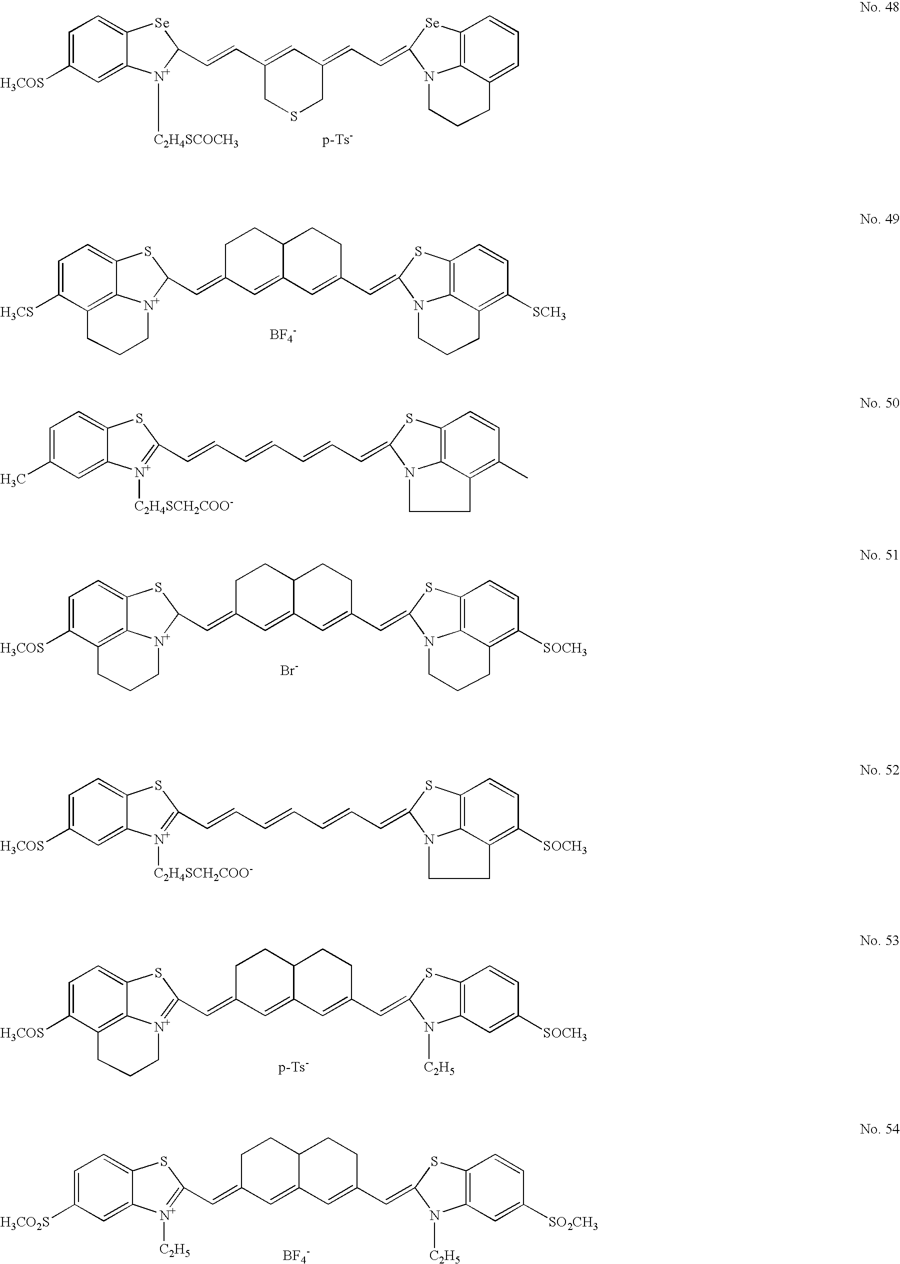

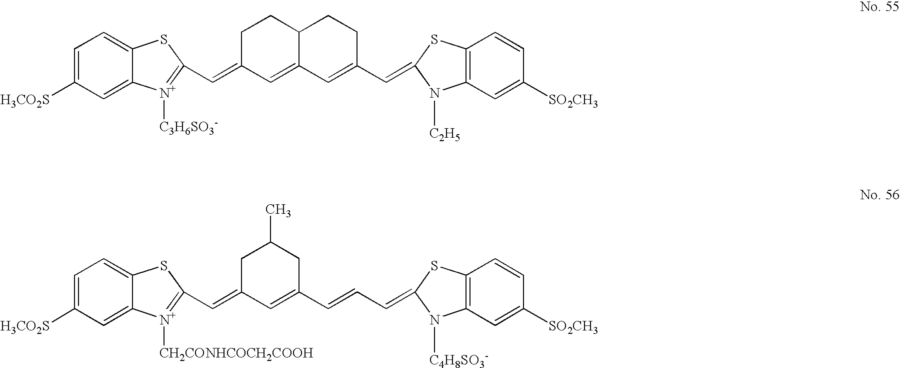

The infrared sensitive dye represented by formulas 3a to 3d to be employed in the invention can be synthesized by methods described in, for example, F. M. Harmer, The Chemistry of Heterocyclic Compounds, Vol. 18, The Cyanine Dyes and Related Compounds (A. Weissberger ed. Interscience, New York, 1964), JP-A Nos. 3-138638 and 10-73900, JP-T No. 9-510022, U.S. Pat. No. 2,734,900, British Patent No. 774,779 and Japanese Patent Applications Nos. 10-269843 and 11-58686.

In the invention, the infrared sensitive dye represented by formulas 3a to 3d may be used alone or in combination. The total amount of the infrared sensitive dye or dyes contained in the silver halide emulsion is 1×10⁻⁶ to 5×10⁻³ moles per 1 mole of silver halide, preferably 1×10⁻⁵ to 2.5×10⁻³ moles and more preferably 4×10⁻⁵ to 1×10⁻³ moles. When at least two photosensitive dyes are used in combination in the invention, such photosensitive dyes can be contained in an arbitrary proportion in the silver halide emulsion.

Examples of the sensitizing dye and a method of addition thereof include those described in JP-A No. 11-65021, paragraphs 0103-0109, a compound represented by formula II in JP-A No. 10-186572, a dye represented by formula I and those described in paragraph 0106 of JP-A No. 11-119374, and in U.S. Pat. No. 5,510,236, a dye described in example 5 of U.S. Pat. No. 3,871,887, dyes disclosed in JP-A Nos. 2-96131 and 59-48753, and those disclosed in EP No. 0,803,764 A1, page 19, line 38 to page 20, line 35, and Japanese Patent Applications Nos. 2000-86865, 2000-102560 and 2000-205399. These sensitizing dyes may be used alone or in combination. In the invention, the sensitizing dye is added to the silver halide emulsion preferably during a period from the end of a desalting process to just before initiation of coating, and more preferably during a period from the end of the desalting process to the end of a chemical ripening process.

In order to improve spectral sensitizing efficiency, a super sensitizer may be employed in the invention. Examples of the super sensitizer employable in the invention includes compounds described in EP No. 587,338, U.S. Pat. Nos. 3,877,943 and 4,873,184, and JP-A Nos. 5-341432, 11-109547 and 10-111543.

The photosensitive silver halide of the invention may contain another already known sensitizing dye and any of the spectral sensitizing dye represented by aforementioned formulas 3-a to 3-d in combination. Examples of such a known sensitizing dye usable in combination and a method of addition thereof include those described in JP-A No. 11-65021, paragraphs 0103-0109, a compound represented by formula II in JP-A No. 10-186572, a dye represented by formula I and those disclosed in paragraph 0106 of JP-A No. 11-119374, and in U.S. Pat. No. 5,510,236, a dye described in example 5 of U.S. Pat. No. 3,871,887, dyes disclosed in JP-A Nos. 2-96131 and 59-48753, and those described in EP No. 0,803,764,A1, page 19, line 38 to page 20, line 35, and Japanese Patent Applications Nos. 2000-86865, 2000-102560 and 2000-205399. These sensitizing dyes may be used alone or in combination. Such a sensitizing dye may be added to the silver halide emulsion preferably during a period from the end of a desalting process to just before initiation of coating. Explanation regarding non-photosensitive organic silver salt

A non-photosensitive organic silver salt employable in the invention is a silver salt that is relatively stable to light but forms a silver image when heated to 80° C. or higher in the presence of an exposed photosensitive silver halide and a reducing agent. The organic silver salt can be an arbitrary organic substance that can supply reducible silver ions. Such a non-photosensitive organic silver salt is described in, for example, JP-A No. 10-62899, paragraphs 0048-0049, EP No. 0,803,764 A1, page 18 line 24 to page 19, line 37, EP No. 0,962,812 A1, and JP-A Nos. 11-349591, 2000-7683 and 2000-72711. A silver salt of an organic acid, particularly a silver salt of a long-chain aliphatic carboxylic acid (with 10 to 30 carbon atoms, preferably 15 to 28 carbon atoms) is preferable as such. Typical examples of the organic silver salt include silver behenate, silver arachidate, silver stearate, silver oleate, silver laurate, silver caproate, silver myristate, silver palmitate, and a mixture thereof. In the invention, it is preferable to use an organic silver salt having a silver behenate content of 30 to 90 mol %, preferably 40 to 70 mol % among these organic silver salts. A silver salt of a long-chain fatty carboxylic acid with 10 to 30 carbon atoms, preferably with 15 to 28 carbon atoms is also preferable.

The shape of the organic silver salt grains employable in the invention is not particularly restricted, but an acicular crystal having a shorter axis and a longer axis is preferable. In the field of the silver halide photosensitive material, an inverse proportional relationship between the size of silver salt crystal grains and a covering power thereof is well known. Such a relationship stands also in the heat developable photosensitive material of the invention, and means that larger grains of the organic silver salt in an image forming part of the heat developable photosensitive material result in a lower covering power, thus reducing image density. It is, therefore, preferable to reduce the size of the organic silver salt. In the invention, the organic silver salt grains have preferably a shorter axis of 0.01 to 0.15 μm and a longer axis of 0.10 to 5.0 μm, and more preferably a shorter axis of 0.01 to 0.15 μm and a longer axis of 0.10 to 4.0 μm.

The grain size distribution of the organic silver salt is preferably monodispersion. Monodispersion means that a percentage, obtained by dividing a standard deviation of the shorter axes by the shorter axis or by dividing a standard deviation of the longer axes by the longer axis, is preferably 100% or less, more preferably 80% or less and still more preferably 50% or less.

The shape of the organic silver salt can be measured from a transmission electron microscope image of an organic silver salt dispersion. The monodispersibility can also be determined by the percentage (variation factor) of a value obtained by dividing a standard deviation of a volume-weighted mean diameter of the organic silver salt grains by the volume-weighted mean diameter. The percentage is preferably 100% or less, more preferably 80% or less and still more preferably 50% or less. Such measurement can be conducted with a commercially available laser-scattering particle size measuring apparatus.

The organic silver salt can be prepared by forming grains in an aqueous solvent, followed by drying, and re-dispersing the grains in a solvent such as MEK. The drying is carried out in an air-flow flush jet dryer preferably with an oxygen partial pressure of 15 vol % or less, more preferably 15 to 0.01 vol % and still more preferably 10 to 0.01 vol %.

The organic silver salt can be employed in a desired amount, but is preferably employed in a silver coated amount of 0.1 to 5 g/m², and more preferably 1 to 3 g/m².

Explanation of Binder

A binder to be employed in the invention can be arbitrarily selected from natural or synthetic resins, for example, gelatin, polyvinyl butyral, polyvinyl acetal, polyvinyl chloride, polyvinyl acetate, cellulose acetate, polyolefin, polyester, polystyrene, polyacrylonitrile, polycarbonate, polyvinyl butyral, butylethyl cellulose, a methacrylate copolymer, a maleic anhydride ester copolymer, and a butadiene-styrene copolymer. Particularly, the photosensitive layer preferably contains polyvinyl butyral as a binder, and more specifically contains polyvinyl butyral as a binder in an amount of 50 mass % or higher with respect to mass of all the binder components in the photosensitive layer. The photosensitive layer can contain a copolymer or a terpolymer including polyvinyl butyral in an amount of 50 mass % or higher with respect to mass of all the binder components in the photosensitive layer. The total amount of polyvinyl butyral is preferably from 50 to 100 mass % with respect to the total amount of binder component(s) of the photosensitive layer, and more preferably from 70 to 100 mass %. The binder preferably has a glass transition temperature Tg within a range of 40 to 90° C., and more preferably 50 to 80° C.

The binder is used in a sufficient amount to hold components of an image forming layer within such a layer. In other words, it is used in an amount effective in functioning as a binder. The effective amount can be appropriately determined by those skilled in the art. In order to hold at least the organic silver salt, the mass ratio of the binder and the organic silver salt is within a range from 15:1 to 1:3, and more preferably 8:1 to 1:2.

Explanation Regarding Developing Accelerator

The heat developable photosensitive material of the invention preferably contains a developing accelerator, and examples thereof include a sulfonamidephenol compound represented by formula A in JP-A Nos. 2000-267222 and 2000-330234, a hindered phenol compound represented by formula II in JP-A No. 2001-92075, a hydrazine compound represented by formula I in JP-A Nos. 10-62895 and 11-15116, formula D in JP-A No. 2002-156727 and formula 1 in JP-A No. 2002-278017, or a phenol or naphthol compound represented by formula 2 in JP-A No. 2001-264929. Such a developing accelerator is used in an amount of 0.1 to 20 mol % with respect to the amount of the reducing agent, preferably 0.5 to 10 mol % and more preferably 1 to 5 mol %. It can be introduced into the photosensitive material in a manner similar to introduction of the reducing agent to the photosensitive material, and it is preferably introduced in the form of a solution in which it is dissolved in an organic solvent.

In the invention, among the aforementioned developing accelerators, the hydrazine compound represented by formula D in JP-A No. 2002-156727 and a phenol or naphthol compound represented by formula 2 in JP-A No. 2001-264929 are particularly preferable.

In the invention, the developing accelerator is particularly preferably compounds represented by the following formulas A-1 and A-2.
Q1-NHNH-Q2 Formula A-1

In the formula, Q1 represents an aromatic group or a heterocyclic group having a carbon atom bonding to —NHNH-Q2; and Q2 represents a carbamoyl group, an acyl group, an alkoxycarbonyl group, an aryloxycarbonyl group, a sulfonyl group or a sulfamoyl group.

In formula A-1, the aromatic group or the heterocyclic group represented by Q1 is preferably a 5- to 7-membered unsaturated ring. Typical examples thereof include a benzene ring, a pyridine ring, a pyradine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, a thiophene ring and a condensed ring formed by mutual condensation of these rings.

These rings may have a substituent, and, in the case where these rings have at least two substituents, such substituents may be mutually same or different. Examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case where such a substituent is a substitutable group, it may have a substituent, and typical examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

A carbamoyl group represented by Q2 preferably has 1 to 50 carbon atoms, and more preferably 6 to 40 carbon atoms, and can be, for example, unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxylcarbonylphenyl)carbamoyl, N-naphthylcarbamoyl, N-3-pyridylcarbamoyl, or N-benzylcarbamoyl.

An acyl group represented by Q2 preferably has 1 to 50 carbon atoms, and more preferably 6 to 40 carbon atoms, and can be, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl. An alkoxycarbonyl group represented by Q2 preferably has 2 to 50 carbon atoms, and more preferably 6 to 40 carbon atoms, and can be, for example, methoxycarbonyl, ethoxycarbonyl, isobutyloxycarbonyl, cyclohexyloxycarbonyl, dodecyloxycarbonyl or benzyloxycarbonyl.

An aryloxycarbonyl group represented by Q2 preferably has 7 to 50 carbon atoms, and more preferably 7 to 40 carbon atoms, and can be, for example, phenoxycarbonyl, 4-octyloxyphenoxycarbonyl, 2-hydroxymethylphenoxycarbonyl, or 4-dodecyloxyphenoxycarbonyl. A sulfonyl group represented by Q2 preferably has 1 to 50 carbon atoms, and more preferably 6 to 40 carbon atoms, and can be, for example, methylsulfonyl, butylsulfonyl, octylsulfonyl, 2-hexadecylsulfonyl, 3-dodecyloxypropylsulfonyl, 2-octyloxy-5-tert-octylphenylsulfonyl or 4-dodecyloxyphenylsulfonyl.

A sulfamoyl group represented by Q2 preferably has 0 to 50 carbon atoms, and more preferably 6 to 40 carbon atoms, and can be, for example, unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, or N-(2-tetradecyloxyphenylsulfamoyl. A group represented by Q2 may further have, in a substitutable position, a group cited before as the substituent group for a 5- to 7-membered unsaturated ring represented by Q1, and, in the case where the group represented by Q2 has at least two substituents, they may be mutually same or different.

Hereinafter, a preferred range of the compound represented by formula A-1 will be explained. Q1 is preferably a 5- or 6-membered unsaturated ring, and more preferably a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring or a ring formed by condensation of the foregoing ring with a benzene ring or an unsaturated hetero ring. Moreover, Q2 is preferably a carbamoyl group, and more preferably a carbamoyl group having a hydrogen atom on a nitrogen atom.

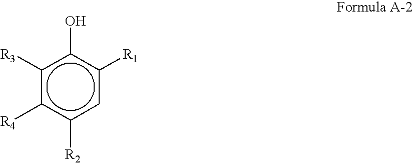

In formula A-2, R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group or a carbonate ester group. R₃ and R₄ each independently represent a group which can bond to the benzene ring, as cited as the examples of the substituent in formula A-1. R₃ and R₄ may bond to each other to form a condensed ring.

R₁ is preferably an alkyl group with 1 to 20 carbon atoms (such as a methyl group, an ethyl group, an isopropyl group, a butyl group, a tert-octyl group, or a cyclohexyl group), an acylamino group (such as an acetylamino group, a benzoylamino group, a methylureido group or a 4-cyanophenylureido group), or a carbamoyl group (such as an n-butylcarbamoyl group, an N,N-diethylcarbamoyl group, a phenylcarbamoyl group, 2-chlorophenylcarbamoyl group, or a 2,4-dichlorophenylcarbamoyl group), and more preferably an acylamino group (including an ureido group and an urethane group).

R₂ is preferably a halogen atom (more preferably a chlorine atom or a bromine atom), an alkoxy group (such as a methoxy group, a butoxy group, an n-hexyloxy group, an n-decyloxy group, a cyclohexyloxy group, or a benzyloxy group), or an aryloxy group (such as a phenoxy group or a naphthoxy group).

R₃ is preferably a hydrogen atom, a halogen atom or an alkyl group with 1 to 20 carbon atoms, and a halogen atom is most preferred. R₄ is preferably a hydrogen atom, an alkyl group, or an acylamino group, and an alkyl group or an acylamino group is more preferred. Typical examples of these groups are similar to those for R₁. In the case where R₄ is an acylamino group, it is also preferable that R₄ is bonded to R₃ so as to form a carbostyryl ring.

In formula A-2, in the case where R₃ and R₄ bond to each other to form a condensed ring, a naphthalene ring is particularly preferable as such a condensed ring. The naphthalene ring may have a substituent and examples of the substituent are the same as those in formula A-1. In the case where a compound of formula A-2 is a naphthol compound, R₁ is preferably a carbamoyl group, and particularly preferably a benzoyl group. R₂ is preferably an alkoxy group or an aryloxy group, and particularly preferably an alkoxy group.

Hereafter, typical examples of the developing accelerator usable in the invention are shown, but the invention is not limited to such examples. 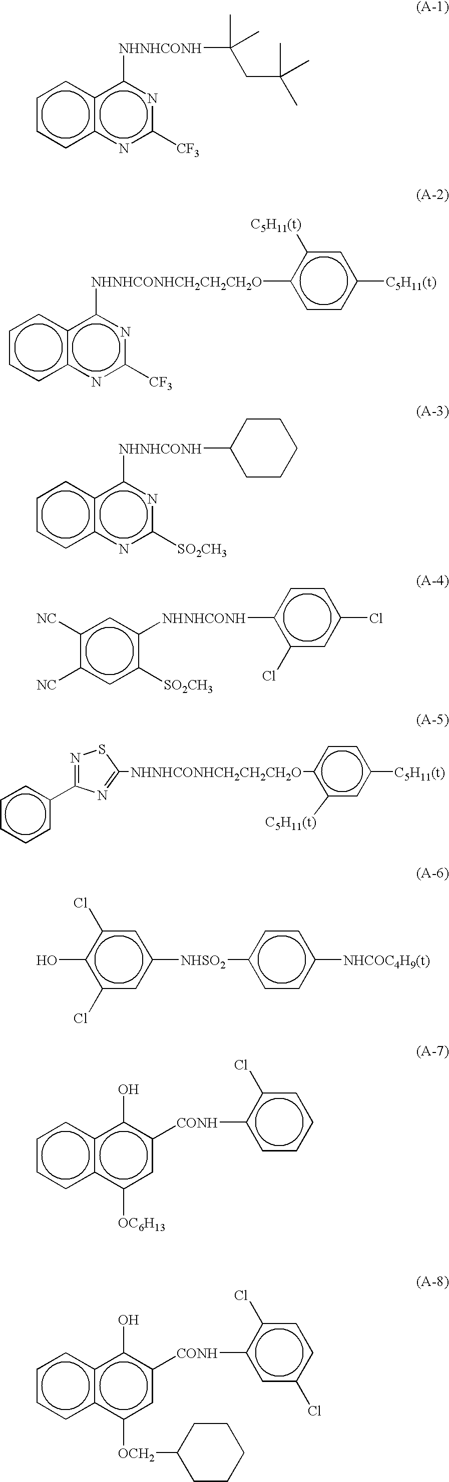 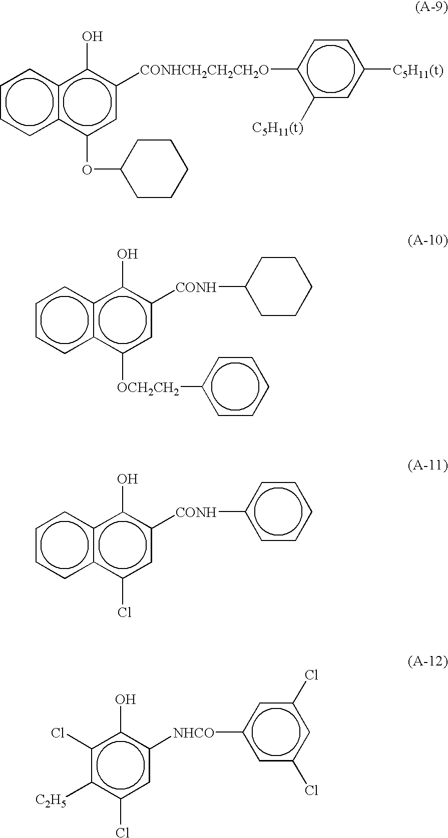
Explanation Regarding Hydrogen Bonding Compound

In the case where the reducing agent of formula R1 or R2 has an aromatic hydroxyl group (—OH) or amino group, particularly in the case where it is a bisphenol compound mentioned above, it is preferable to employ a non-reducible compound having a group capable of forming a hydrogen bond with such a group.

The group capable of forming a hydrogen bond with the hydroxyl group or amino group can be, for example, a phosphoryl group, a sulfoxide group, a sulfonyl group, a carbonyl group, an amide group, an ester group, an urethane group, an ureido group, a tertiary amino group or a nitrogen-containing aromatic group. Among these, a compound having a phosphoryl group, a sulfoxide group, an amide group (however not including >N—H group but being blocked as shown by >N—Ra (Ra being a substituent other than a hydrogen atom)), an urethane group (however not including >N—H group but being blocked as shown by >N—Ra (Ra being a substituent other than a hydrogen atom)), or an ureido group (however not including >N—H group but being blocked as shown by >N—Ra (Ra being a substituent other than a hydrogen atom)) is preferable.

In the invention, the hydrogen bonding compound is a particularly preferably represented by the following formula D:

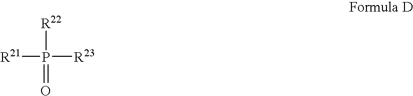

In formula D, R²¹ to R²³ each independently represent an alkyl group, an aryl group, an alkoxy group, an aryloxy group, an amino group or a heterocyclic group, which may be unsubstituted or substituted.

In the case where any of R²¹ to R²³ has a substituent, such a substituent can be a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group. Among them, an alkyl group or an aryl group such as a methyl group, an ethyl group, an isopropyl group, a t-butyl group, a t-octyl group, a phenyl group, a 4-alkoxyphenyl group or a 4-acyloxylphenyl group is preferable.

Specific examples of an alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, and a 2-phenoxypropyl group.

Specific examples of an aryl group represented by R²¹ to R²³ include a phenyl group, a cresyl group, a xylyl group, a naphthyl group, a 4-t-butylphenyl group, a 4-t-octylphenyl group, a 4-anisidyl group and a 3,5-dichlorophenyl group.

Specific examples of an alkoxy group represented by R²¹ to R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Specific examples of an aryloxy group represented by R²¹ to R²³ include a phenoxy group, a cresyloxy group, an isopropylphenoxy group, a 4-t-butylphenoxy group, a naphthoxy group and a biphenyloxy group.

Specific examples of an amino group represented by R²¹ to R²³ include a dimethylamino group, a diethylamino group, a dibutylamino group, a dioctylamino group, an N-methyl-N-hexylamino group, a dicyclohexylamino group, a diphenylamino group and an N-methyl-N-pehnylamino group.

Specific examples of the heterocyclic group represented by R²¹ to R²³ include the following compounds.

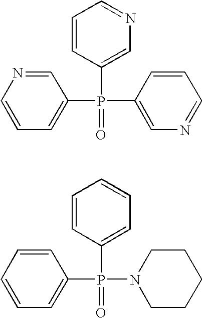

Each of R²¹ to R²³ is preferably an alkyl group, an aryl group, an alkoxy group, or an aryloxy group. From the viewpoint of the effect of the invention, it is preferable that at least one of R²¹ to R²³ is an alkyl group or an aryl group, and more preferable that at least two of R²¹ to R²³ are independently an alkyl group or an aryl group. It is also preferable that R²¹ to R²³ are same groups because of inexpensiveness and availability.

Hereinafter, specific examples of the hydrogen bonding compound usable in the invention, including the compound of formula D, are shown, but the invention is not limited to such examples.

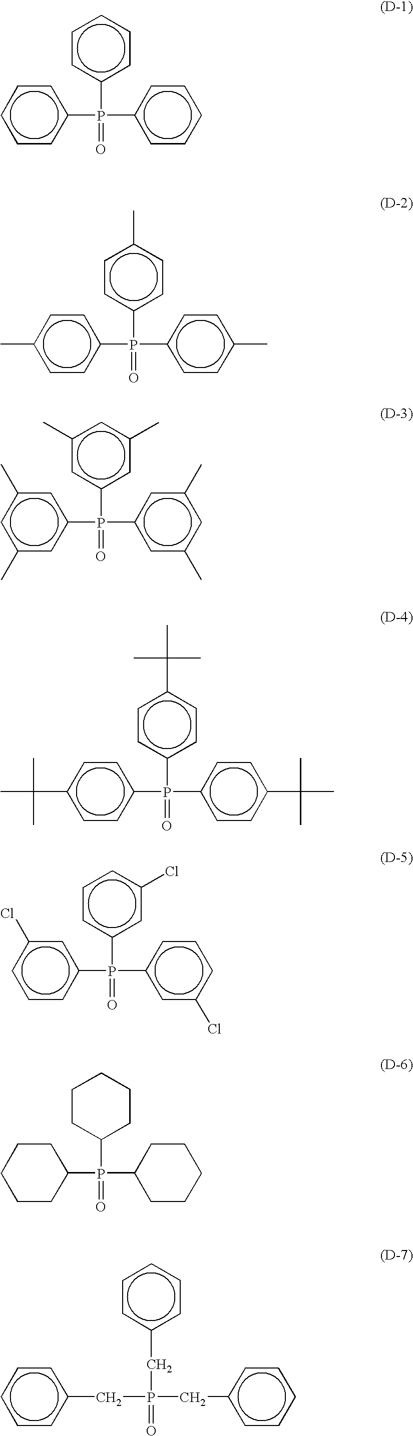

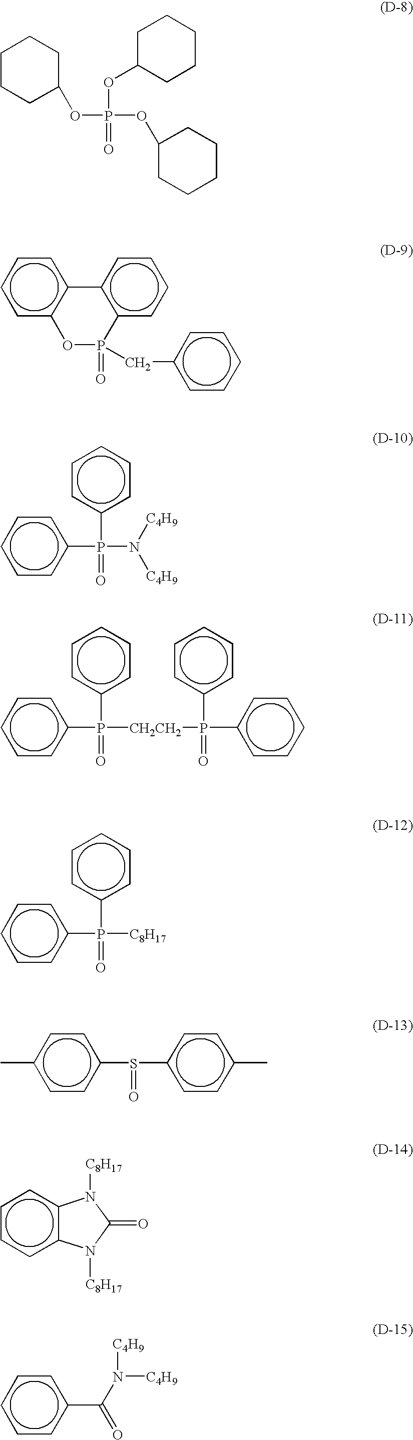

Specific examples of the hydrogen bonding compound which are other than those described above are described in European Patent No. 1,096,310, JP-A No. 2002-156727 and JP-A No. 2002-31841.

Like the reducing agent, the compound of formula D, may be contained in the coating liquid and used in the photosensitive material in the form of a solution, an emulsified dispersion or a dispersion of fine solid particles, but is preferably used in the form of a solution. The compound forms, in a solution state, a complex by hydrogen bonding with a compound having a phenolic hydroxyl group or an amino group, and may be isolated as a crystalline complex depending on the combination of the reducing agent and the compound of formula D.

The compound of formula D is preferably employed in an amount of 1 to 200 mol %, more preferably 10 to 150 mol % and still more preferably 20 to 100 mol % with respect to the amount of the reducing agent.

Explanation Regarding Antifogging Agent

An antifogging agent, a stabilizer and a stabilizer precursor employable in the invention can be compounds described in JP-A No. 10-62899, paragraph 0070, EP No. 0,803,764 A1, page 20, line 57 to page 21, line 7, JP-A Nos. 9-281637 and 9-329864, U.S. Pat. No. 6,083,681, and European Patent No. 1,048,975. Also, an antifogging agent advantageously employed in the invention is an organic halide which can be compounds described in JP-A No. 11-65021, paragraphs 0111-0112. An organic halide represented by formula P in JP-A No. 2000-284399, an organic polyhalide represented by formula II in JP-A No. 10-339934, and organic polyhalides described in JP-A Nos. 2001-31644 and 2001-33911 are particularly preferable.

1) Polyhalide

Hereinafter, an organic polyhalide preferred in the invention will be explained in detail. The polyhalide preferred in the invention is represented by the following formula H.
Q-(Y)n-C(Z₁)(Z₂)X Formula H:

In formula H, Q represents an alkyl group, an aryl group or a heterocyclic group; Y represents a divalent connecting group; n represents 0 or 1; Z₁ and Z₂ each represent a halogen atom; and X represents a hydrogen atom or an electron-attractive group.

In formula H, Q is preferably an aryl group or a heterocyclic group.

In the case where Q is a heterocyclic group in formula H, Q is preferably a nitrogen-containing heterocyclic group including one or two nitrogen atoms, and particularly preferably a 2-pyridyl group or a 2-quinolyl group.

In the case where Q is an aryl group in formula H, Q preferably represents a phenyl group substituted with an electron-attractive group having a Hammett's substituent constant σp of a positive value. As to the Hammett's substituent constant, Journal of Medicinal Chemistry, 1973, Vol. 16, No. 11, 1207-1216 can be referred to. Such an electron-attractive group can be, for example, a halogen atom (such as fluorine atom (σp: 0.06), a chlorine atom (σp: 0.23), a bromine atom (σp: 0.23) or an iodine atom (σp: 0.18)), a trihalomethyl group (such as tribromomethyl (σp: 0.29), trichloromethyl (σp: 0.33) or trifluoromethyl (σp: 0.54)), a cyano group (σp: 0.66), a nitro group (σp: 0.78), an aliphatic, aryl or heterocyclic sulfonyl group (such as methanesulfonyl (σp: 0.72)), an aliphatic, aryl or heterocyclic acyl group (such as acetyl (σp: 0.50) or benzoyl (σp: 0.43)), an alkynyl group (such as C≡CH (σp: 0.23)), an aliphatic, aryl or heterocyclic oxycarbonyl group (such as methoxycarbonyl (σp: 0.45) or phenoxycarbonyl (σp: 0.44)), a carbamoyl group (σp: 0.36), a sulfamoyl group (σp: 0.57), a sulfoxide group, a heterocyclic group or a phosphoryl group. The σp value is preferably within a range of 0.2 to 2.0, and more preferably 0.4 to 1.0. The electron-attractive group is particularly preferably a carbamoyl group, an alkoxycarbonyl group, an alkylsulfonyl group, or an alkylphosphoryl group, and most preferably a carbamoyl group.

X is preferably an electron-attractive group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, and particularly preferably a halogen atom. The halogen atom is preferably a chlorine atom, a bromine atom or an iodine atom, more preferably a chlorine atom or a bromine atom and particularly preferably a bromine atom.

Y preferably represents —C(═O)—, —SO— or —SO₂—, more preferably —C(═O)— or —SO₂—, and particularly preferably —SO₂—. n represents 0 or 1, and preferably represents 1.

Hereafter, specific examples of the compound of formula H are shown, but the invention is not limited to such examples.

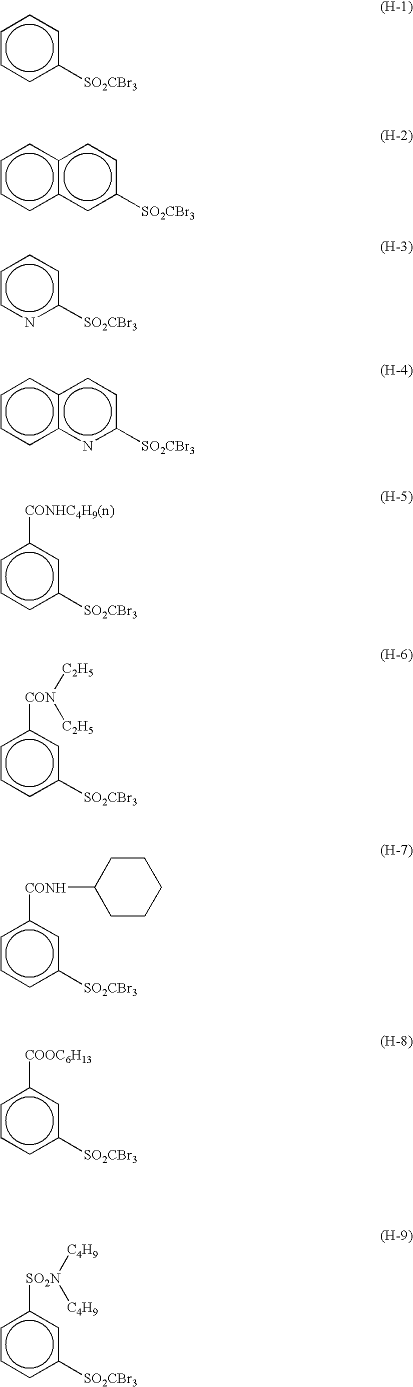

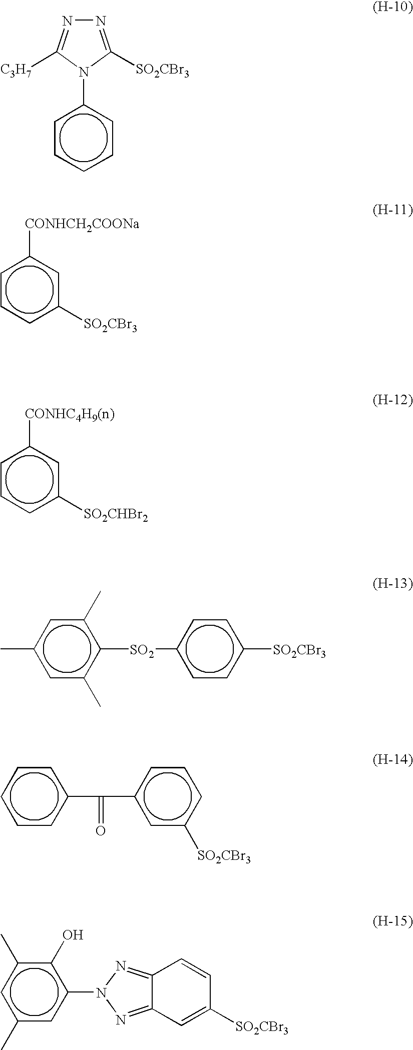

The polyhalide preferably employed in the invention, other than those described above, can be those described in JP-A Nos. 2001-31644, 2001-56526 and 2001-209145.

The compound of formula H is preferably used in an amount of 10⁻⁴ to 1 mole, more preferably 10⁻³ to 0.5 moles, and still more preferably 1×10⁻² to 0.2 moles per 1 mole of the non-photosensitive silver salt in the image forming layer.

In the invention, the method for adding the anti-fogging agent into the heat developable photosensitive material include the same method as the method of adding the reducing agent, and the organic polyhalide is preferably added in the form of a solution in which it is dissolved in an organic solvent.

2) Other Anti-Fogging Agents

Examples of another anti-fogging agent include a mercury (II) salt described in JP-A No. 11-65021, paragraph 0113, a benzoic acid described in JP-A No. 11-65021, paragraph 0114, a salicylic acid derivative described in JP-A No. 2000-206642, a formalin scavenger compound represented by formula S in JP-A No. 2000-221634, a triazine compound described in claim 9 of JP-A No. 11-352624, a compound represented by formula III in JP-A No. 6-11791, and 4-hydroxy-6-methyl-1,3,3a,7-tetrazaindene.

The heat developable photosensitive material of the invention may include an azolium salt for the purpose of fog prevention. The azolium salt can be a compound represented by formula XI in JP-A No. 59-193447, a compound described in JP-B No. 55-12581, or a compound represented by formula II in JP-A No. 60-153039. The azolium salt may be added to any part of the photosensitive material, but it is preferably added to a layer on a side having the photosensitive layer and more preferably added to the organic silver salt-containing layer. The azolium salt may be added in any step of preparation of the coating liquid, and, in the case where it is added to the organic silver salt-containing layer, it is added in any step from preparation of the organic silver salt to preparation of the coating liquid, but preferably during a period from just after end of preparation of the organic silver salt to just before initiation of coating. The azolium salt may be added in the form of powder, a solution or a dispersion of fine particles. Also, it may be added as a mixed solution includng another additive such as a sensitizing dye, a reducing agent or a color toning agent as well as the azolium salt. In the invention, the azolium salt may be added in any amount, but preferably in an amount of 1×10⁻⁶ to 2 moles, and more preferably in an amount of 1×10⁻³ to 0.5 moles per 1 mole of silver.

Other Additives

1) Mercapto, Disulfide and Thion

In the invention, for the purposes of suppression or acceleration of developing, improving efficiency of spectral sensitization, improving preservability before and after developing, the photosensitive material may include a mercapto compound, a disulfide compound and/or a thion compound such as those described in JP-A No. 10-62899, paragraphs 0067-0069, those represented by formula I in JP-A No. 10-186572 and specific example described in JP-A No. 10-186572, paragraphs 0033-0052, and those described in EP No. 0,803,764 A1, page 20, lines 36-56. Among these, mercapto-substituted heteroaromatic compounds described in JP-A No. 9-297367, 9-304875 and 9-304875 and 2001-100358, and Japanese Patent Applications Nos. 2001-104213 and 2001-104214 are preferable.

2) Color Toning Agent

The heat developable photosensitive material of the invention preferably contains a color toning agent. The color toning agent is described in JP-A No. 10-62899, paragraphs 0054-0055, EP No. 0,803,764 A1, p. 21, lines 23 to 48, JP-A Nos. 2000-356317 and 2000-187298. A phthalazinone (phthalazinone, a phthalazinone derivative or a metal salt thereof, such as 4-(1-naphthyl)phthalazinone, 6-chlorophthalazinone, 5,7-dimethoxyphthazinone or 2,3-dihydro-1,4-phthalazindione); a combination of a phthalazinone and a phthalic acid (such as phthalic acid, 4-methylphthalic acid, 4-nitrophthalic acid, diammonium phthalate, sodium phthalate, potassium phthalate or tetrachlorophthalic anhydride); a phthalazine (phthalazine, a phthalazine derivative or a metal salt thereof, such as 4-(1-naphtyl)phthalazine, 6-isopropylphthalazine, 6-t-butylphthalazine, 6-chlorophthalazine, 5,7-dimethoxyphthalazine or 2,3-dihydrophthalazine); or a combination of a phthalazine and a phthalic acid and is more preferable, and a combination of a phthalazine and a phthalic acid is particularly preferable. Among such a combination, a combination of 6-isopropylphthazine and phthalic acid or 4-methylphthalic acid is particularly preferable.

3) Benzoic Acid

The heat developable photosensitive material of the invention may contain a benzoic acid or a derivative thereof for the purpose of improving sensitivity or preventing fog. Any derivative of benzoic acid may be employed, but typical examples thereof include compounds described in U.S. Pat. Nos. 4,784,939 and 4,152,160 and JP-A Nos. 9-281687, 9-329864 and 9-329865. The benzoic acid compound employed in the invention may be added to any part of the photosensitive material, but it is preferably added to a layer on a side having the photosensitive layer and more preferably added to the organic silver salt-containing layer. The benzoic acid compound may be added in any step of preparation of the coating liquid, and, in the case where it is added to the organic silver salt-containing layer, it is added in any step from preparation of the organic silver salt to preparation of the coating liquid, but preferably during a period from just after end of peparation of the organic silver salt to just before initiation of coating. The benzoic acid compound may be added in the form of powder, a solution or a dispersion of fine particles. Also, it may be added as a mixed solution including another additive such as a sensitizing dye, a reducing agent or a color toning agent as well as the benzoic acid compound. In the invention, the benzoic acid compound may be added in any amount, but preferably in an amount of 1 μmol to 2 moles, and more preferably from 1 mmol to 0.5 moles per 1 mole of silver.

4) Plasticizer, and Lubricant

A plasticizer and a lubricant employable in the photosensitive layer of the invention are described in JP-A No. 11-65021, paragraph 0117. Moreover, a super contrasting agent, a method and an amount of addition thereof are described in JP-A No. 11-65021, paragraph 0118, JP-A No. 11-223898, paragraphs 0136-0193, formulas H, 1 to 3, A and B in JP-A No. 2000-284399, formulas III to V (specific compounds in formulas 21-24) in JP-A No. 2000-347345, and a contrast enhancing agent is described in JP-A No. 11-65021, paragraph 0102 and JP-A No. 11-223898, paragraphs 0194-0195.

5) Dye, and Pigment

The photosensitive layer of the invention may include any dye and pigment (e.g., C. I. Pigment Blue 60, C. I. Pigment Blue 64, or C. I. Pigment Blue 15:6) for the purposes of color tone improvement, prevention of interference fringes at the time of laser exposure and prevention of irradiation. These are described in detail in, for example, WO98/36322, and JP-A Nos. 10-268465 and 11-338098.

6) Super Contrasting Agent

In order to form an ultra highly contrasty image suitable for printing platemaking, the image forming layer preferably contains a super contrasting agent. The super contrasting agent, a method of addition thereof and an amount of addition thereof are described for example in JP-A No. 11-65021, paragraph 0118, JP-A No. 11-223898, paragraphs 0136-0193, formulas H, 1 to 3, A and B in JP-A No. 2000-284399, formulas III to V (specific compounds in formulas 21-24) in JP-A No. 2000-347345, and a contrast enhancing agent is described in JP-A No. 11-65021, paragraph 0102 and JP-A No. 11-223898, paragraphs 0194-0195.

In order to employ formic acid or a formate salt as a strong fogging substance, the super contrasting agent is preferably added to a side having the image forming layer containing a photosensitive silver halide, in an amount of 5 mmol or less, and more preferably 1 mmol or less per 1 mole of silver.

In the case where the super contrasting agent is used in the heat developable photosensitive material of the invention, it is preferable to use an acid formed by hydration of phosphorous pentoxide or a salt thereof. Examples of the acid formed by hydration of phosphorous pentoxide or a salt thereof include metaphosphoric acid (and salt thereof), pyrophosphoric acid (and salt thereof), orthophosphoric acid (and salt thereof), triphosphoric acid (and salt thereof), tetraphosphoric acid (and salt thereof), and hexametaphosphoric acid (and salt thereof) The acid formed by hydration of phosphorous pentoxide or the salt thereof can be particularly preferably orthophosphoric acid (or salt thereof), or hexametaphosphoric acid (or salt thereof). Specific examples of the salt include sodium orthophosphate, sodium dihydrogen orthophosphate, sodium hexametaphosphate and ammonium hexametaphosphate.

The amount (coating amount per 1 m² of the photosensitive material) of the acid formed by hydration of phosphorous pentoxide or the salt thereof may be suitably selected according to desired performance such as sensitivity or fog level, but is preferably 0.1 to 500 mg/m² and more preferably 0.5 to 100 mg/m².

Explanation Regarding Layer Configuration and Other Components

The heat developable photosensitive material of the invention may have a non-photosensitive layer as well as the image forming layer. The non-photosensitive layer can be classified, based on a position thereof, into (a) a surface protective layer provided on the image forming layer (namely farther from the substrate), (b) an intermediate layer provided between a plurality of image forming layers or between the image forming layer and the protective layer, (c) an undercoat layer provided between the image forming layer and the substrate, and (d) a back layer provided at a side opposite to the image forming layer.

The heat developable photosensitive material of the invention may have a layer functioning as an optical filter, which is formed as a layer (a) or (b). Also an antihalation layer is provided as a layer (c) or (d) in the photosensitive material.

1) Surface Protective Layer

The heat developable photosensitive material of the invention may have a surface protective layer, for example for preventing sticking of the image forming layer. The surface protective layer may be formed by a single layer or by a plurality of layers.

A binder for the surface protective layer may be any polymer. Examples of such a binder include polyester, gelatin, polyvinyl alcohol, and a cellulose derivative, and a cellulose derivative is preferable. Examples of the cellulose derivative include, but are not limited to, cellulose acetate, cellulose acetate butyrate, cellulose propionate, hydroxypropyl cellulose, hydroxypropylmethyl cellulose, methyl cellulose, hydroxyethyl cellulose, carboxymethyl cellulose and a mixture thereof. The surface protective layer preferably has a thickness of 0.1 to 10 μm, and particularly preferably 1 to 5 μm.

In the surface protective layer, any sticking preventing material may be employed. Examples of the sticking preventing material include wax, liquid paraffin, silica particles, a styrene-containing block copolymer having an elastomer property (such as styrene-butadiene-styrene, or styrene-isoprene-styrene), cellulose acetate, cellulose acetate butyrate, cellulose propionate and a mixture thereof.

2) Antihalation Layer

An antihalation layer may be provided at a side farther than the photosensitive layer from an exposure light source. The antihalation layer is described in JP-A No. 11-65021, paragraphs 0123-0124, JP-A Nos. 11-223898, 9-230531, 10-36695, 10-104779, 11-231457, 11-352625 and 11-352626.

The antihalation layer includes an antihalation dye having an absorption in an exposure wavelength. The heat developable photosensitive material of the invention has an exposure wavelength in an infrared region, and an infrared absorbing dye can be employed as the antihalation dye, but, even in such a case, the infrared absorbing dye preferably has no sub-absorption in the visible region.

In the case where halation is prevented with a dye having a sub-absorption in the visible region, it is preferable that the color of the dye does not substantially remain after image formation. It is preferable to employ a means for eliminating color by heat at the time of thermal developing, and it is particularly preferable to add a dye whose color can be removed when heated (thermally color-removable dye) and a base precursor in the non-photosensitive layer serving as the antihalation layer. Such technology is described in, for example, JP-A No. 11-231457.

The amount of the color-removable dye added is determined according to use of the dye. In general, it is used in such an amount that optical density (absorbance) measured at a desired wavelength is higher than 0.1. The optical density is preferably within a range from 0.2 to 2. The amount of the dye to obtain such optical density is generally within a range of about 0.001 to 1 g/m².

By removing the color of the dye, it is possible to reduce optical density after thermal developing to 0.1 or less. It is also possible to use at least two color-removable dyes in combination in a thermally color-removable recording material or a heat developable photosensitive material. Similarly, it is possible to use at least two base precursors in combination.

In such thermal color removal utilizing the color-removable dye and the base precursor, it is preferable, from the viewpoint of thermal color-removing property, to use in combination a substance (such as diphenylsulfon, or 4-chlorophenyl(phenyl)sulfon) that can lower a melting point by 3° C. or more when mixed with the base precursor, as described in JP-A No. 11-352626.

3) Back layer

A back layer that can be employed in the invention is described in JP-A No. 11-65021, paragraphs 0128-0130.

A binder for the back layer is transparent or translucent, and is generally colorless and can be a natural polymer, or a synthetic resin, polymer or copolymer, or another film-forming substance. Specific examples thereof include gelatin, gum Arabic, polyvinyl alcohol, hydroxyethyl cellulose, cellulose acetate, cellulose acetate butyrate, polyvinylpyrrolidone, casein, starch, polyacrylic acid, polymethylmethacrylic acid, polyvinyl chloride, polymethacrylic acid, a styrene-maleic anhydride copolymer, a styrene-acrylonitrile copolymer, a styrene-butadiene copolymer, polyvinylacetal (such as polyvinyl formal or polyvinyl butyral), polyester, polyurethane, a phenoxy resin, polyvinylidene chloride, polyepoxide, polycarbonate, polyvinyl acetate, cellulose ester, and polyamide. The binder may be dissolved or emulsified in water or an organic solvent to form a coating liquid.

The heat developable photosensitive material of the invention may contain a coloring agent having an absorption maximum at 300 to 450 nm in order to improve a color tone of silver image and to reduce change of the image over time. Such a coloring agent is described in, for example, JP-A Nos. 62-210458, 63-104046, 63-103235, 63-208846, 63-306436, 63-314535, and 01-61745 and JP-A No. 2001-100363. Such a coloring agent is contained usually in an amount of 0.1 mg/m² to 1 g/m², and preferably in a back layer formed at an opposite side of the photosensitive layer.

4) Matting Agent

The heat developable photosensitive mateiral of the invention preferably contain a matting agent in the surface protective layer and in the back layer in order to improve a transporting property.

The emulsion surface of the heat developable photosensitive material of the invention may have any matting degree as long as it does not have so-called stardust failure showing a small white spot in an image area and causing a light leakage. However, the Bekk smoothness of the heat developable photosensitive material of the invention is preferably within a range of 200 to 10,000 seconds, and particularly preferably 300 to 8,000 seconds. The Bekk smoothness can be easily determined by JIS P8119 “Smoothness testing method with Bekk's tester for paper and board”, and TAPPI standard method T479.

In the invention, the back layer preferably has as a matting degree Bekk smoothness of 250 to 10 seconds, and more preferably 180 to 50 seconds.

In the invention, the matting agent is preferably included in an outermost surface layer of the photosensitive material, a layer functioning as an outermost surface layer, or a layer close to the external surface, and it is preferably included in a layer functioning as a protective layer.

The matting agent employable in the invention is organic or inorganic fine particles insoluble in the coating solvent. A matting agent well known in the related art, for example an organic matting agent described in U.S. Pat. Nos. 1,939,213, 2,701,245, 2,322,037, 3,262,782, 3,539,344 and 3,767,448, and an inorganic matting agent described in U.S. Pat. Nos. 1,260,772, 2,192,241, 3,257,206, 3,370,951, 3,523,022 and 3,769,020 can be employed. Specific examples of the organic compound employable as the matting agent includes a water-dispersible vinylic polymer (e.g., polymethyl acrylate, polymethyl methacrylate, polyacrylonitrile, an acrylonitrile-α-methylstyrene copolymer, polystyrene, a styrene-divinylbenzene copolymer, polyvinyl acetate, polyethylene carbonate, and polytetrafluoroethylene); a cellulose derivative (e.g., methyl cellulose, cellulose acetate and cellulose acetate propionate); a starch derivative (e.g., carboxystarch, carboxynitrophenylstarch, an urea-formaldehyde-starch reaction product); gelatin hardened with a known hardening agent; and hardened gelatin formed into fine hollow microcapsules by coacervation hardening. Moreover, examples of the inorganic compound include silicon dioxide, titanium dioxide, magnesium dioxide, aluminum oxide, barium sulfate, calcium carbonate, silver chloride desensitized by a known method, silver bromide desensitized by a known method, glass or diatom earth. These matting agents may be employed as a mixture of different materials, if necessary. The size or shape of the matting agent is not particularly restricted, and those having an arbitrary particle size can be employed. In the invention, the particle size is preferably within a range from 0.1 to 30 μm. Furthermore, the matting agent may have a narrow or wide particle size distribution. On the other hand, since the matting agent significantly influences the haze and surface gloss of the photosensitive material, it is preferable to obtain a desired particle size, a desired shape and a desired particle size distribution of the matting agent at the time of preparation of the matting agent or by mixing a plurality of matting agents.

5) Film Hardening Agent

A film hardening agent may be used in the photosensitive layer, the protective layer, and/or the back layer of the invention.

Examples of the film hardening agent are described in T. H. James, “The Theory of the Photographic Process Fourth Edition” (Macmillan Publishing Co. Inc., 1977) pp. 77-87, and chromium alum, sodium 2,4-dichloro-6-hydroxy-s-triazine, N,N-ethylenebis(vinylsulfonacetamide), N,N-propylenebis(vinylsulfonacetamide), a polyvalent metal ion described in p. 78 of the aforementioned reference, a polyisocyanate described in U.S. Pat. No. 4,281,060 and JP-A No. 6-208193, an epoxy compound described in U.S. Pat. No. 4,791,042 and a vinylsulfone compound described in JP-A No. 62-89048 can be preferably employed.

The film hardening agent is added as a solution, and a timing of addition of such a solution to the coating liquid is within a period starting from 180 minutes before coating operation and ending immediately before the coating operation, preferably within a period from 60 minutes before the coating operation to 10 seconds before the coating operation, but a mixing method and mixing conditions are not particularly restricted as long as the effect of the invention can be sufficiently exhibited.

Specific examples of the mixing method include a mixing method in which mixing is conducted in a tank in order to obtain a desired average residence period based on a flow rate of addition and the amount of a liquid supplied to a coater, and a method utilizing a static mixer, as described in N. Harnby, M. F. Edwards, A. W. Nienow, “Liquid Mixing Technologies” (translated by Koji Takahashi, Nikkan Kogyo Shimbunsha, 1989), chapter 8.

6) Surfactant

The heat developable photosensitive material of the invention may contain a surfactant in order to improve coatability or chargeability. Any surfactant, such as a nonionic, anionic, cationic or fluorinated surfactant, may be employed in a suitable manner. Specific examples thereof include a fluorinated polymer surfactant described in JP-A No. 62-170950 and U.S. Pat. No. 5,380,644, a fluorinated surfactant described in JP-A Nos. 60-244945 and 63-188135, a polysiloxane surfactant described in U.S. Pat. No. 3,885,965, and a polyalkylene oxide and an anionic surfactant described in JP-A No. 6-301140.

In the invention, it is particularly preferable to employ a fluorinated surfactant. Typical examples of the fluorinated surfactant include compounds described in JP-A Nos. 10-197985, 2000-19680 and 2000-214554. A fluorinated polymer surfactant described in JP-A No. 9-281636 can also be preferably employed. In the invention, it is particularly preferable to employ a fluorinated surfactant described in JP-A No. 2002-082411.

7) Coating Solvent

Examples of a solvent are described in, for example, Yozai Pocket Book (solvent pocket book), new edition (Ohm Co., 1994), but the invention is not limited to such examples. The solvent to be employed in the invention preferably has a boiling point within a range from 40 to 180° C. Specific examples of the solvent include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propanesultone, perfluorotributylamine, and water. Among these, methyl ethyl ketone is advantageously employed as it has a suitable boiling point, and can provide a uniform surface on a coated film, and is easily removed, which results in a small amount of the solvent remaining in the coating film.

Preferably, the solvent employed in coating remains as little as possible in the coated film, after coating and drying. A residual solvent generally evaporates to the environment at the time of exposure of the heat developable photosensitive material or at the time of thermal developing thereof, thereby causing an unpleasant feeling to the user and an undesirable effect to the health thereof.

In particular, the effect of in the heat developable photosensitive material of the invention has to do with the residual solvent as will be shown in examples. It is an unexpected phenomenon that a high sensitivity and a high stability are obtained only in a region where the amount of the residual solvent is small. In the case where the amount of the residual solvent is high, the heat developable photosensitive material shows a high sensitivity immediately after manufactured by coating, but loses the sensitivity during storage. In order to exhibit the effect of the invention, it is important to reduce the amount of the residual solvent. When the solvent is MEK, the amount of residual solvent is preferably within a range of 0.1 to 150 mg/m², more preferably 0.1 to 80 mg/m², and still more preferably 0.1 to 40 mg/m².

8) Antistatic Agent

The heat developable photosensitive material of the invention may have an antistatic layer including a known metal oxide or a conductive polymer. The antistatic layer may also serve as the undercoat layer, the back surface protective layer mentioned above, or may be formed separately therefrom. To the antistatic layer, technologies described in JP-A No. 11-65021, paragraph 0135, JP-A Nos. 56-143430, 56-143431, 58-62646 and 56-120519, JP-A No. 11-84573, paragraphs 0040-0051, U.S. Pat. No. 5,575,957 and JP-A No. 11-223898, paragraphs 0078-0084 may be applied.

9) Substrate

A substrate can be a polyester film, an undercoated polyester film, a polyethylene terephthalate film, a polyethylene naphthalate film, a cellulose nitrate film, a cellulose ester film, a polyvinylacetal film, a polycarbonate film, a related or resinous material, glass, paper, or a metal. A flexible substrate, particularly a paper substrate which is partially acetylated or coated with baryta and/or an α-olefin polymer, particularly an α-olefin polymer with 2 to 10 carbon atoms such as polyethylene, polypropylene or an ethylene-butene copolymer can also be employed. The substrate can be transparent or opaque, but is -preferably transparent.

The substrate is preferably a polyester, particularly polyethylene terephthalate, subjected to a heat treatment at a temperature ranging from 130 to 185° C. in order to relax an internal strain remaining in the film at the time of biaxial orientation and eliminate a thermal shrinking strain caused at the time of thermal developing.

In the case of the heat developable photosensitive material of the invention is used in medical use, the transparent substrate may be colored with a blue dye (e.g., a dye 1 described in examples of JP-A No. 8-240877), or may be colorless. Specific examples of such a substrate are described in JP-A No. 11-65021, paragraph 0134.

An undercoating technology, for example, with a water-soluble polyester described in JP-A No. 11-84574, a styrene-butadiene copolymer described in JP-A No. 10-186565, or a vinylidene chloride copolymer described in JP-A No. 2000-39684 and JP-A No. 2001-83679, paragraphs 0063-0080 is preferably applied to the substrate.

10) Other Additives

The heat developable photosensitive material may contain an antioxidant, a stabilizer, a plasticizer, an ultraviolet absorbent and an auxiliary coating agent. Also, a solvent described in JP-A No. 11-65021, paragraph 0133 may be used. These additives are contained either in the photosensitive layer or in the non-photosensitive layer. As for these aditives, WO No. 98/36322, EP No. 803,764 A1, JP-A Nos. 10-186567 and 10-18568 can be referred to.

11) Coating Method

The heat developable photosensitive material of the invention may be produced by any coating method. More specifically, various coating methods including extrusion coating, slide coating, curtain coating, dip coating, knife coating, flow coating and extrusion coating utilizing a hopper described in U.S. Pat. No. 2,681,294 can be used, and extrusion coating or slide coating described in Stephen F. Kistler and Petert M. Schweizer, “Liquid Film Coating” (Chapman & Hall, 1997), pp. 399-536 is preferably employed, and extrusion coating is particularly preferable.

12) Packaging Material

The heat developable photosensitive material of the invention is preferably packaged and sealed by a packaging material having a low oxygen permeability and/or a low moisture permeability in order to avoid alteration of the photographic performance during storage before use, and, in the case where the photosensitive material is rolled, to prevent curling or bending of the photosensitive material. The oxygen permeability of the packaging material at 25° C. is preferably 50 ml/atm/m²·day or less, more preferably 10 ml/atm/m²·day or less, and still more preferably 1.0 ml/atm/m²·day or less. The moisture permeability of the packaging material is preferably 10 g/atm/m²·day or less, more preferably 5 g/atm/m²·day or less, and still more preferably 1 g/atm/m²·day or less. Specific examples of the packaging material having a low oxygen permeability or a low moisture permeability include those described in JP-A Nos. 8-254793 and 2000-206653.

13) Other Applicable Technologies

Examples of other technologies applicable to the heat developable photosensitive material of the invention include those described in EP Nos. 803,764 A1 and 883,022 A1, WO No. 98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, and 11-343420, Japanese Patent Applications Nos. 2000-187298, 2000-10229, 2000-47345, 2000-206642, 2000-98530, 2000-98531, 2000-112059, 2000-112060, 2000-112104, 2000-112064 and 2000-171936.

Explanation of Image Forming Method

1) Exposure

The photosensitive material of the invention may be exposed by any method, but laser light is preferable as exposure light. The amount of light on the surface of the photosensitive material is preferably 0.1 to 100 W/mm², more preferably 0.5 to 50 W/mm², and most preferably 1 to 50 W/mm².

A gas laser (Ar⁺, He—Ne, He—Cd), a YAG laser, a dye laser, or a semiconductor laser is employed as the laser light source. It is also possible to use a semiconductor laser and a second harmonic generating element. The laser to be used is determined according to the optical absorption peak wavelength of a spectral sensitizing dye and the like in the heat developable photosensitive material, but is a He—Ne laser emitting infrared light, or a semiconductor laser emitting infrared light. Among these, an infrared semiconductor laser is particularly preferable since it is inexpensive and can emit stably light and therefore is suitable to design a laser image output system which is compact, has a satisfactory operability and can be easily installed in any location.

Laser light oscillating in a longitudinal multi mode, for example, by a high frequency superposing method can also be employed advantageously.

2) Thermal Developing

The heat developable photosensitive material of the invention may be developed by any method, but is usually developed by heating the heat developable photosensitive material exposed imagewise. A developing temperature is preferably 80 to 250° C., and more preferably 100 to 140° C. A developing time is preferably 1 to 180 seconds, more preferably 10 to 90 seconds, and most preferably 10 to 14 seconds.

For thermal developing, a plate heater method is preferable. A method described in JP-A No. 11-133572 which employs a thermal developing apparatus having a plate heater as a heating means and a plurality of press rollers disposed along one surface of the plate heater and in which the heat developable photosensitive material having a latent image thereon passes a nip between the press rollers and the plate heater and is heated by the pate heater to conduct thermal developing is preferable for thermal developing with a plate heater method. It is preferable to divide the plate heater into 2 to 6 stages and to lower the temperature of a leading end stage by 1 to 10° C. with respect to the temperature of other stages.

Such a method is also described in JP-A No. 54-30032, can eliminate, from the system, moisture or organic solvent contained in the heat developable photosensitive material and can suppress change in the shape of the substrate of the heat developable photosensitive material which change results from rapid heating of the photosensitive material.

Moreover, it is also possible to provide a heating resistance layer on a rear surface of the heat developable photosensitive material as described in U.S. Pat. Nos. 4,460,681 and 4,374,921 and to supply current to the heating resistance layer so as to heat the material.

3) System

An example of a laser imager system for medical use having an exposure unit and a thermal developing unit is Fuji Medical Dry Imager FM-DPL. This system is described in Fuji Medical Review No. 8, p. 39-55, and the technology described therein can be utilized. Moreover, the heat developable photosensitive material can be utilized as that for a laser imager in an AD Network proposed by Fuji Medical Co. as a network system meeting the DICOM standard.

Explanation of Application of the Invention

The heat developable photosensitive material of the invention forms a monochrome image by a silver image, and is preferably utilized as a heat developable photosensitive material for medical diagnosis, a heat developable photosensitive material for industrial photography, a heat developable photosensitive material for printing and a heat developable photosensitive material for COM.

### EXAMPLES

Hereinafter, the invention will be explained by way of examples thereof, but the invention is not limited by such examples.

### Example 1

1. Preparation of PET Substrate and Undercoating

1-1. Film Formation

Terephthalic acid and ethylene glycol were polymerized by an ordinary method to obtain a PET having an intrinsic viscosity IV, measured at 25° C. in a mixture of phenol and tetrachloroethane at an weight ratio of 6/4, of 0.66. The PET was pelletized, then dried for 4 hours at 130° C., and fused at 300° C. A dye BB having the following structure was added to the fused PET so that the content of the dye became 0.04 wt %. Then, the colored PET was extruded from a T-die and cooled rapidly to obtain a film which had not been drawn and which had a thickness providing a film thickness of 175 μm after thermal fixation.

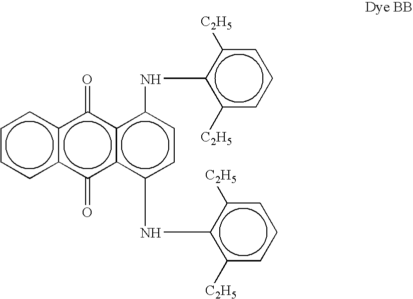

The film was then drawn in the longitudinal direction with rollers driven at different peripheral speeds so that the length thereof in the longitudinal direction was 3.3 times as long as the original length thereof in the direction, and drawn in the lateral direction with a tenter so that the length thereof in the lateral direction was 4.5 times as long as original length thereof in the direction. The temperatures at the time of drawing were 110° C. and 130° C., respectively. Then, after the film was thermally fixed for 20 seconds at 240° C., it was relaxed in the lateral direction by 4% at 240° C. After portions chucked by the tenter were slit off, knurling was applied to both sides of the film, and the film was wound under a tension of 4 kg/cm² to obtain a roll of a film having a thickness of 175 μm.

1-2. Surface Treatment with Corona Discharge

A solid-state corona discharge treating apparatus model 6KVA, manufactured by Pillar Inc., was employed to treat both surfaces of the resultant substrate at a speed of 20 m/min at room temperataure. Based on current and voltage values applied in this operation, it was confirmed that the substrate was treated at 0.375 kV·A·min/m². In this treatment, the frequency was 9.6 kHz and the clearance between an electrode and a dielectric roll was 1.6 mm.

2. Preparation of Coating Liquid for Back Layer and Coating

While 830 g of MEK was agitated, 84.2 g of cellulose acetate butyrate (CAB381-20 manufactured by Eastman Chemical Co.) and 4.5 g of a polyester resin (Vitel PE2200B manufactured by Bostic Co.) were added to and dissolved in the MEK. 0.30 g of a dye B, and a solution in which 4.5 g of a fluorinated surfactant (Surflon KH40 manufactured by Asahi Glass Co.) and 2.3 g of a fluorinated surfactant (Megafac F120K manufactured by Dainippon Ink and Chemicals Inc.) were dissolved in 43.2 g of methanol were added to thus obtained solution, and the resultant mixture was sufficiently agitated to dissolve these components. Finally, a dispersion which was obtained by dispersing 75 g of silica (Siloid 64X6000 manufactured by W. R. Grace Co.) in methyl ethyl ketone with a dissolver-type homogenizer and whose silica concentration was 1 wt % was added to the resultant solution and the resulting mixture was agitated to obtain a coating liquid for a back surface.

The coating liquid for the back surface protective layer thus prepared was coated on the substrate and dried by an extrusion coater so as to obtain a dried film thickness of 3.5 μm. The resultant layer was dried for 5 minutes at a drying temperature of 100° C. with a drying air of a dew-point temperature of 10° C.

3. Image Forming Layer, Intermediate Layer and Surface Protective Layer

3-1. Preparation of Materials of Coating Liquids

1) Preparation of Silver Halide Emulsion

88.3 g of phthalated gelatin, 10 ml of a 10% methanol-water solution of a PAO compound (HO(CH₂CH₂O)ₙ—(CH(CH₃)CH₂O)₁₇—(CH₂CH₂O)ₘ—H; m+n=5 to 7) and 0.32 g of potassium bromide were added to and dissolved in 5429 ml of water, and the resultant solution was maintained at 40° C. 659 ml of a 0.67 mol/l aqueous solution of silver nitrate and a solution containing 0.703 moles of KBr and 0.013 moles of KI per 1 liter of the solution were added to the above solution over a period of 4 minutes and 45 seconds by a simultaneous mixing method, utilizing a mixing-agitating machine described in JP-B Nos. 58-58288 and 58-58289 while pAg was kept at 8.09, thereby performing nucleation. One minute later, 20 ml of a 0.63N solution of potassium hydroxide were added to the resulting mixture. After lapse of 6 minutes, 1976 ml of a 0.67 mol/l aqueous solution of silver nitrate and a solution containing 0.657 moles of KBr, 0.013 moles of potassium iodide and 30 μmol of dipotassium hexachloroiridate per 1 liter of the solution were added to the resulting mixture over a period of 14 minutes and 15 seconds by a simultaneous mixing method at 40° C. while pAg was kept at 8.09. After the resulting mixture was agitated for 5 minutes, it was cooled to 38° C.

Then, 18 ml of a 56% aqueous solution of acetic acid were added to the mixture so as to precipitate silver halide emulsion. The supernatant was eliminated to leave 2 liters of a precipitated portion, 10 liters of water were added to the remainder, the resultant was agitated, and then the silver halide emulsion was precipitated again. The supernatant was eliminated to leave 1.5 liters of a precipitated portion, 10 liters of water were added to the remainder, the resultant was agitated, and the silver halide emulsion was precipitated again. Then, the supernatant was eliminated to leave 1.5 liters of a precipitated portion, and a solution containing 1.72 g of anhydrous sodium carbonate in 151 ml of water was added to the remainder, and the resulting mixture was heated to 55° C. and agitated for 120 minutes. Finally, the pH was adjusted to 5.0, and water was added to the mixture in an amount of 1161 g per 1 mole of silver.

The resultant emulsion had monodisperse cubic silver iodobromide grains with a silver iodide content of 2%, an average grain size of 40 nm, a variation factor of grain size of 12%, and a [100] plane percentage of 92%.

2) Preparation of Organic Silve Salt Powder

0.3776 moles of behenic acid, 0.2266 moles of arachidic acid, and 0.1510 moles of stearic acid were dissolved in 4720 ml of purified water at 80° C., and 540.2 ml of a 1.5N aqueous solution of sodium hydroxide and 6.9 ml of concentrated nitric acid were added to the resultant solution. The resulting mixture was cooled to 55° C. and a solution of sodium salts of organic acids was thus obtained. While the aforementioned solution of sodium salts of organic acids was maintained at 55° C., 45.3 g of the aforementioned silver halide emulsion and 450 ml of purified water were added thereto, and the resulting mixture was agitated for 5 minutes with a homogenizer (Ultra-Turra XT-25 manufactured by IKA Japan Co.) at 13,200 rpm (21.1 kHz as mechanical oscillation frequency). Then, 702.6 ml of a 1 mol/l solution of silver nitrate were added to the mixture over a period of 2 minutes, and the resultant was agitated for 10 minutes and an organic silver salt dispersion was thus obtained. Thereafter, the obtained organic silver salt dispersion was transferred to a rinsing container, deionized water was added to the dispersion and the resultant mixture was agitated and allowed to stand still. Then, the organic silver salt dispersion separated from and floated on the remaining aqueous phase, and water-soluble salts were removed with removal of the aqueous phase from the container. These operations of rinsing of the dispersion with deionized water and removal of rinsing water from the dispersion were repeated until the conductivity of the discharged aqueous phase reached 2 μS/cm. The resulting dispersion was dehydrated by centrifugation, and the solvent contained in the dispersion was removed in a circulating drier with a warm air of an oxygen partial pressure of 10 vol % at 40° C. until the weight of the obtained product no longer decreased. An organic silver salt powder containing photosensitive silver halide was thus obtained.

3) Preparation of Dispersion of Organic Silve Salt Containing Photosensitive Silve Halide

14.57 g of polyvinyl butyral powder (Butvar B-79 manufactured by Monsant Co.) was dissolved in 1457 g of methyl ethyl ketone (MEK) and 500 g of the aforementioned organic silver salt powder were gradually added to and sufficiently mixed with the resultant solution, which was being agitated with a dissolver Dispermat CA-40M manufactured by VMA-Getzmann Co., to obtain a slurry.

The slurry was subjected to a 2-pass dispersion with a pressurized homogenizer GM-2 manufactured by SMT Co. to obtain an organic silver salt dispersion containing a photosensitive emulsion. In this operation, a processing pressure in the first pass was 280 kg/cm², and a processing pressure in the second pass was 560 kg/cm².

4) Preparation of Photosensitive Layer Coating Liquid-1

15.1 g of MEK was added to 50 g of the organic silver salt dispersion. The resultant dispersion was maintained at 21° C. and agitated with a dissolver type homogenizer at 1,000 rpm. 390 μl of a 10 wt % methanol solution of an aggregate of 2 molecules of N,N-dimethylacetamide, 1 molecule of hydrogen bromide and 1 molecule of bromine were added to the dispersion and the resultant mixture was agitated for 1 hour. Then, 494 μl of a 10 wt % methanol solution of calcium bromide was added to the mixture and the resultant was agitated for 20 minutes.

Then, 167 mg of a methanol solution containing 15.9 wt % of dibenzo-18-crown-6 and 4.9 wt % of potassium acetate was added to the above mixture, followed by agitation for 10 minutes. 18.3 mass % of 2-chlorobenzoic acid, 34.2 mass % of salicylic acid-p-toluenesulfonate and 2.6 g a sensitizing dye No. 41 (in 2.4 mass % MEK solution) were added to the resultant mixture, followed by agitation for 1 hour. Thereafter, the resultant mixture was cooled to 13° C. and further agitated for 30 minutes. While the mixture was maintained at 13° C., 13.31 g of polyvinyl butyral (Butvar B-79 manufactured by Monsant Co.) was added to the mixture, followed by agitation for 30 minutes. 1.08 g of a 9.4 wt. % solution of tetrachlorophthalic acid was added to the resultant mixture, followed by agitation for 15 minutes. While the resultant was continuously agitated, a reducing agent-1 for comparison was added thereto in an amount of 0.4 moles per 1 mole of silver.

12.4 g of an MEK solution containing 1.1 mass % of 4-methylphthalic acid and a dye 1, 1.5 g of 10 mass % Desmodur N3300 (aliphatic isocyanate manufactured by Movey Inc.) were successively added to the resulting mixture. Further, 13.7 g of a 7.4 mass % MEK solution of polyhalogen compound-1 and 4.27 g of a 7.2 mass % MEK solution of phthalazine were added to the resultant mixture to obtain a photosensitive layer coating liquid 1.

5) Preparation of Coating Liquid for Surface Protective Layer

96 g of cellulose acetate butyrate (CAB171-15 manufactured by Eastman Chemical Co.), 4.5 g of polymethylmethacrylic acid (Paraloid A-21 manufactured by Rohm and Haas Co.), 1.5 g of 1,3-di(vinylsulfonyl)-2-propanol, 1.0 g of benzotriazole and 1.0 g of a fluorinated surfactant (Surflon KH40 manufactured by Asahi Glass Co.) were added to and dissolved in 865 g of MEK, which was being agitated. Then, 30 g of a dispersion prepared by dispersing 13.6 wt % of cellulose acetate butyrate (CAB171-15 manufactured by Eastman Chemical Co.) and 9 wt % of calcium carbonate (Super-Pflex 200 manufactured by Speciality Minerals Inc.) in MEK with a dissolver-type homogenizer for 30 minutes at 8,000 rpm were added to the resultant solution and the resultant was agitated. A surface protective layer coating liquid was thus obtained.

6) Preparation of Coating Liquid for Back Layer and Coating

84.2 g of cellulose acetate butyrate (CAB381-20 manufactured by Eastman Chemical Co.) and 4.5 g of a polyester resin (Vitel PE2200B manufactured by Bostic Co.) were added to and dissolved in 830 g of MEK, which was being agitated. 0.30 g of the dye B and a solution in which 4.5 g of a fluorinated surfactant (Surflon KH40 manufactured by Asahi Glass Co.) and 2.3 g of a fluorinated surfactant (Megafac F120K manufactured by Dainippon Ink and Chemicals Inc.) were dissolved in 43.2 g of methanol were added to and, through sufficient agitation, dissolved in the obtained solution. Finally, a dispersion prepared by dispersing 75 g of silica in methyl ethyl ketone at a concentration of 1 wt % with a dissolver-type homogenizer were added to the resulting solution and the resultant was agitated and a back layer coating liquid was thus obtained.

The back layer coating liquid thus prepared was coated on the substrate and dried by an extrusion coater so as to obtain a dried film thickness of 3.5 μm. The resultant layer was dried for 5 minutes at a drying temperature of 100° C. with a drying air of a dew-point temperature of 10° C.

3-2. Preparation of Heat Developable Photosensitive Material-1

A heat developable photosensitive material 1 was prepared by coating the photosensitive layer coating liquid-1 and the surface protective layer coating liquid simultaneously on a surface of the substrate coated with the back layer which surface was opposite to the back layer by an extrusion coater to form superposed layers. Coating was conducted such that the coated silver amount of the photosensitive layer was 1.9 g/m² and that a dry film thickness of the surface protective layer was 2.5 μm. Then, these layers was dried for 10 minutes at a drying temperature of 75° C. with a drying air of a dew-point temperature of 10° C.

3-3. Preparation of Heat Developable Photosensitive Material-2-20

Heat developable photosensitive materials-2 to -20 were prepared in the same manner as the preparation of the heat developable photosensitive material-1 except that the reducing agent-1 for comparison in the heat developable photosensitive material-1 was replaced with reducing agents of formulae R1 and R2 as shown in Table 1. In Table 1, the amount of the reducing agent(s) added is represented by a relative molar ratio with respect to mol of the reducing agent-1 for comparison in the photosensitive material-1. Namely, 100% indicates that the total molar amount of the reducing agents of formulas R1 and R2 or the addition amount of the reducing agent-1 for comparison is equal to the addition amount of the reducing agent-1 in sample 001, namely 0.4 moles per 1 mole of silver.

Hereafter, compounds employed in examples are shown. 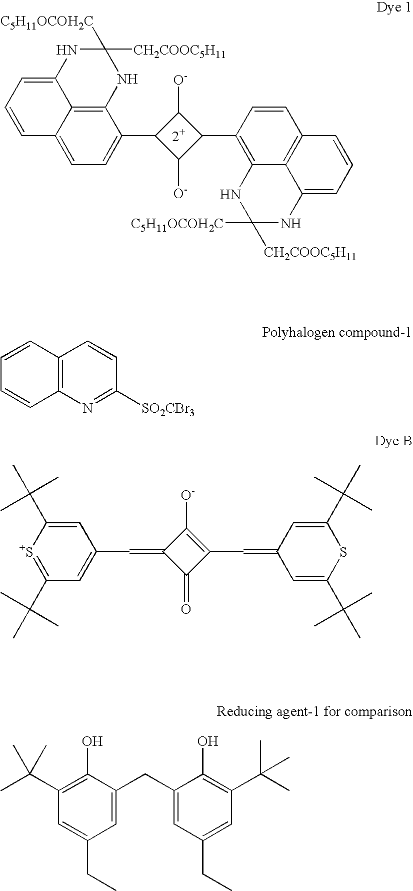
3-3. Exposure and Developing

An exposure apparatus having as an exposure source a semiconductor laser of a longitudinal multi mode emitting light having a wavelength of 800 to 820 nm by high frequency superposing was prepared and used to conduct laser scan exposure to each of the prepared samples Nos. 1 to 36 from the image forming layer side thereof. In this operation, an image was recorded by scanning laser beams having an incident angle of 75° to an exposed surface of each photosensitive material. Then, samples were thermally developed for 15 seconds at 124° C. in an automatic developing apparatus having a heat drum by bringing the samples in contact with the surface of the drum. An obtained image on each sample was evaluated with a densitometer. The temperature and humidity of a room used for exposure and developing were 23° C. and 50% RH, respectively.

Sensitivity

A relative sensitivity ΔS1.5 was determined from a logarithmic value of an exposure amount providing a density 1.5 (taking a sample No. 1 as reference).

Color Tone Change

Practical images were prepared by outputting a computed radiography photograph of a chest part and an MRI cross-sectional photograph, followed by processing under standard developing conditions, and were evaluated with naked eyes on a light box (schaukasten). The evaluation was made by 10 observers, and the result was rated as “++” in the case where the image had color tone preferred by 9 or more observers, as “+” in the case where the image had color tone preferred by 7 or 8 observers, as “±” in the case where the image had color tone preferred by 4 to 6 observers, and as “−” in the case where the image had color tone preferred by 3 or less observers. In the case of an evaluation of “±” or “−”, the direction of deviation of the color tone was also evaluated.

Dependence on Conditions of Thermal Developing

Also, each sample was thermally developed in the same manner as in the above-described developing except developing conditions were changed as follows: with respect to the standard condition, (1) the temperature of each heating plate was changed by ±2° C., (2) a total developing time was changed by ±2 seconds, (3) a temperature of each heating plate was changed by +1° C. and a total developing time was changed by +1 second, (4) a temperature of each heating plate was changed by −1° C. and a total developing time was changed by −1 second, (5) a temperature of each heating plate was changed by +2° C. and a total developing time was changed by −2 seconds, (6) a temperature of each heating plate was changed by −2° C. and a total developing time was changed by +2 seconds. The developing time was changed by varying transporting speed of each sample, whereby the developing times on the heating plates were uniformly changed. a* and b* values were measured at a portion of each sample which portion had a density of 1.5 and plotted on an a*-b* coordinate. The distance r {square root of ((Δa*)²+(Δb*)²)} of two farthest points among thus plotted points was calculated and was used for evaluation of color tone stability of each image. Δa* and Δb* indicate the difference between a* values of the farthest two points and the difference between b* values of the farthest two points, respectively. A smaller r value is preferred as it indicates a smaller difference in color tones of images developed under different developing conditions. The a* and b* values were calculated for a light source FLF5 based on the CIE 1976 standard.

Results of evaluation of color tone are indicated by one of four levels: color tone whose r value was less than 0.5 was rated as “++”, color tone whose r value was not less than 0.5 but less than 1.0 was rated “+”, color tone whose r value was not less than 1.0 but less than 2.0 was rated as “±” and color tone whose r value was not less than 2.0 was rated as “−”. These results well coincided with those of the organoleptic evaluation with naked eyes.

TABLE 1

| | Reducing agent of | | Reducing agent of | | | Color | | | |
|---|---|---|---|---|---|---|---|---|---|
| | formula R1 | | formula R2 | | Relative | tone in | | | |
| Sample | | coating | | coating | sensitivity | standard | Color tone stability | | Remarks |
| No. | type | amount | type | amount | ΔS | development | max distance (R) | Evaluation *1 | *2 |
| 001 | comp. reduc- | 100% | — | — | ±0 | ±(purple) | ± | ± | comp. ex. |
| | ing agent | | | | | | | | |
| 002 | R1-4 | 100% | — | — | −0.12 | −(purple) | evaluation | evaluation | comp. ex. |
| | | | | | | | impossible | impossible | |
| 003 | R1-7 | 100% | — | — | −0.16 | −(purple) | evaluation | evaluation | comp. ex. |
| | | | | | | | impossible | impossible | |
| 004 | — | — | R2-1 | 100% | +0.11 | −(yellow) | evaluation | evaluation | comp. ex. |
| | | | | | | | impossible | impossible | |
| 005 | — | — | R2-4 | 100% | −0.04 | + | − | − | comp. ex. |
| 006 | comp. reduc- | 90% | R2-1 | 10% | +0.08 | ±(yellow) | ± | ± | comp. ex. |
| | ing agent | | | | | | | | |
| 007 | comp. reduc- | 70% | R2-4 | 30% | −0.01 | ±(yellow) | ± | ± | comp. ex. |
| | ing agent | | | | | | | | |
| 008 | R1-4 | 90% | R2-1 | 10% | +0.04 | ++ | ++ | ++ | pres. inv. |
| 009 | R1-4 | 70% | R2-2 | 30% | −0.02 | + | + | ++ | pres. inv. |
| 009* | R1-4 | 70% | R2-2 | 30% | +0.03 | ++ | + | ++ | pres. inv. |
| 010 | R1-4 | 60% | R2-2 | 40% | +0.01 | + | ++ | ++ | pres. inv. |
| 011 | R1-4 | 50% | R2-2 | 50% | 0.00 | ±(yellow) | + | + | pres. inv. |
| 012 | R1-4 | 70% | R2-4 | 30% | −0.01 | + | + | ++ | pres. inv. |
| 013 | R1-4 | 70% | R2-9 | 30% | +0.02 | + | + | + | pres. inv. |
| 014 | R1-4 | 80% | R2-13 | 20% | +0.03 | + | + | + | pres. inv. |
| 015 | R1-7 | 90% | R2-1 | 10% | +0.02 | ++ | ++ | ++ | pres. inv. |
| 016 | R1-7 | 70% | R2-4 | 30% | −0.03 | + | + | ++ | pres. inv. |
| 017 | R1-7 | 80% | R2-8 | 20% | +0.01 | + | + | + | pres. inv. |
| 018 | R1-1 | 70% | R2-3 | 30% | −0.01 | + | + | + | pres. inv. |
| 019 | R1-10 | 70% | R2-3 | 30% | −0.03 | + | + | + | pres. inv. |
| 020 | R1-12 | 70% | R2-3 | 30% | −0.02 | + | + | + | pres. inv. |

Note:
In sample 009*, the amount of development accelerator-1 was more than that in sample 009 by 20%.
*1 organoleptic evaluation
*2 comp. Ex. = comparative example; pres. inv. = present invention

Results in Table 1 indicate that samples 008 to 020 which are included in the invention are excellent heat developable photosensitive materials with an excellent color tone under standard developing and with little variation of color tone under varied developing conditions.

### Example 2

1) Preparation of Photosensitive Layer Coating Liquid

As in example 1, 15.1 g of MEK were added to 50 g of the organic silver salt dispersion, which was being agitated, in a nitrogen flow. The resultant mixture was maintained at 24° C. Then, 2.5 ml of a 10 mass % methanol solution of the following antifoggant 1 was added to the mixture and the resultant mixture was agitated for 15 minutes. Then, 2.5 g of a sensitizing dye No. 5 (in 0.24 mass % MEK solution) and 1.8 ml of a solution containing the following dye adsorption aid and potassium acetate at a mass mixing ratio of 1:5 and having a dye adsorption aid amount of 20 mass % were added to the mixture and the resultant mixture was agitated for 15 minutes. Then, 7 ml of a mixed solution containing 4-chloro-2-benzyolbenzoic acid and, as a super sensitizer, 5-methyl-2-mercaptobenzimidazole at a mass mixing ratio of 25:2 (a methanol solution of 3.0 mass % in total), 3.5×10⁻³ moles of polyhalogen compound-1, reducing agent-1 for comparison and reducing agents of formulae R1 and R2 as shown in Table 2 were added to the mixture and the resultant mixture was agitated for 1 hour, cooled to 13° C. and further agitated for 30 minutes. While the mixture was maintained at 13° C., 48 g of polyvinyl butyral was added to and sufficiently dissolved in the mixture, and the following additives were added to the resulting mixture. All the operations were conducted under a nitrogen flow. The amount of the reducing agent(s) added is indicated according to the same definition shown in example 1.

| | | |
|---|---|---|
| phthalazine | 1.5 | g |
| tetrachlorophthalic acid | 0.5 | g |
| 4-methylphthalic acid | 0.5 | g |
| hydrogen bonding compound-1 | 0.67 | g |
| developing accelerator-1 | 0.046 | g |
| developing accelerator-2 | 0.039 | g |
| dye-2 | 2.0 | g |
| Desmodur N3300 (aliphatic isocyanate | 1.10 | g |
| manufactured by Movey) | | |

Dye adsorption aid

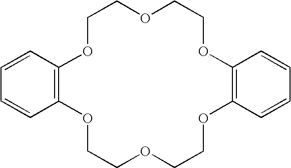

Antifoggant 1

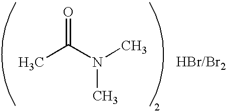

Dye 2

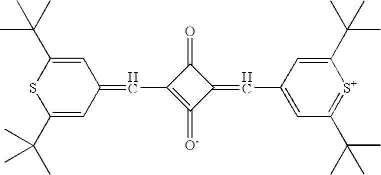

Antifoggant 2

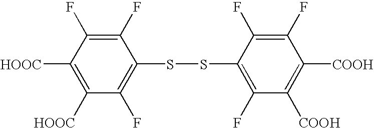

Hydrogen bonding compound-1

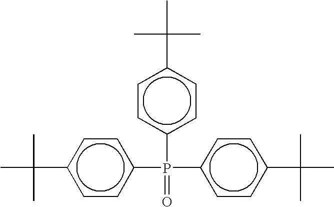

Developing accelerator-1

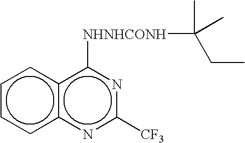

Developing accelerator-2

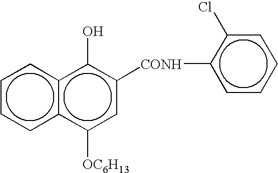

2) Coating

Image forming layer: The substrate coated with a back layer was prepared in the same manner as in example 1. The aforementioned image forming layer coating liquid was coated on a substrate surface opposite to the back layer so as to obtain a coated silver amount of 1.8 g/m² and the amount of polyvinyl butyral binder of 8.5 g/m².

Surface protective layer: The following coating liquid was coated on the image forming layer so as to obtain a wet coating thickness of 100 μm:

| | | |
|---|---|---|
| acetone | 175 | ml |
| 2-propanol | 40 | ml |
| methanol | 15 | ml |
| cellulose acetate | 8 | g |
| phthalazine | 1.5 | g |
| 4-methylphthalazine | 0.72 | g |
| tetrachlorophthalic acid | 0.22 | g |
| tetrachlorophthalic anhydride | 0.5 | g |
| monodisperse silica (average particle size: 4 μm, | | |
| variation factor: 20%) | | |
| 1 mass % with respect to the binder | 0.5 | g |
| fluorinated surfactant (Surflon KH40 manufactured by | | |
| Asahi Glass Co.) | | |

3) Exposure and Thermal Developing

The resultant heat developable photosensitive materials were exposed to light and thermally developed in the same manner as in example 1. Characteristics of the obtained images were measured in the same manner as in example 1 and the results are shown in Table 2.

TABLE 2

| | Reducing agent of | | Reducing agent of | | | Color | | | |
|---|---|---|---|---|---|---|---|---|---|
| | formula R1 | | formula R2 | | Relative | tone in | Color tone stability | | |
| Sample | | coating | | coating | sensitivity | standard | max distance | Evaluation | Remarks |
| No. | type | amount | type | amount | ΔS | development | (R) | *1 | *2 |
| 101 | comp. reduc- | 100% | — | — | ±0 | ±(purple) | + | ± | comp. ex. |
| | ing agent | | | | | | | | |
| 102 | R1-4 | 100% | — | — | −0.10 | −(purple) | evaluation | evaluation | comp. ex. |
| | | | | | | | impossible | impossible | |
| 103 | R1-7 | 100% | — | — | −0.13 | −(purple) | evaluation | evaluation | comp. ex. |
| | | | | | | | impossible | impossible | |
| 104 | — | — | R2-1 | 100% | +0.10 | −(yellow) | evaluation | evaluation | comp. ex. |
| | | | | | | | impossible | impossible | |
| 105 | — | — | R2-4 | 100% | −0.03 | + | − | − | comp. ex. |
| 106 | comp. reduc- | 85% | R2-1 | 15% | +0.06 | ±(yellow) | ± | ± | comp. ex. |
| | ing agent | | | | | | | | |
| 107 | comp. reduc- | 60% | R2-4 | 40% | −0.04 | ±(yellow) | ± | ± | comp. ex. |
| | ing agent | | | | | | | | |
| 108 | R1-4 | 90% | R2-1 | 10% | +0.03 | + | + | ++ | pres. inv. |
| 109 | R1-4 | 85% | R2-1 | 15% | −0.03 | + | ++ | ++ | pres. inv. |
| 110 | R1-4 | 80% | R2-1 | 20% | +0.02 | ++ | + | ++ | pres. inv. |
| 111 | R1-4 | 60% | R2-2 | 40% | +0.03 | + | + | + | pres. inv. |
| 112 | R1-4 | 60% | R2-4 | 40% | −0.02 | + | + | ++ | pres. inv. |
| 112* | R1-4 | 60% | R2-4 | 40% | +0.03 | ++ | + | ++ | pres. inv. |
| 113 | R1-4 | 80% | R2-18 | 20% | +0.01 | + | + | + | pres. inv. |
| 114 | R1-4 | 70% | R2-18 | 30% | +0.02 | + | + | + | pres. inv. |
| 115 | R1-7 | 85% | R2-1 | 15% | +0.04 | ++ | ++ | ++ | pres. inv. |
| 116 | R1-7 | 70% | R2-4 | 30% | −0.01 | + | + | ++ | pres. inv. |
| 117 | R1-7 | 80% | R2-18 | 20% | +0.01 | + | + | + | pres. inv. |
| 118 | R1-5 | 70% | R2-3 | 30% | 0.00 | + | + | + | pres. inv. |
| 119 | R1-6 | 70% | R2-3 | 30% | −0.01 | + | + | + | pres. inv. |
| 120 | R1-18 | 70% | R2-3 | 30% | −0.03 | + | + | + | pres. inv. |

Note:
In sample 112*, the amounts of development accelerators-1 and -2 were more than the respective amounts thereof in sample 112 by 10%.
*1 organoleptic evaluation
*2 comp. Ex. = comparative example; pres. inv. = present invention

Results in Table 2 indicate that samples 108 to 120 which are included in the invention are excellent heat developable photosensitive materials with an excellent color tone under standard developing and with little variation of color tone under varied developing conditions.

### Example 3

Samples were prepared in the same manner as in example 1 except that the sensitizing dye No. 41 was replaced with a sensitizing dye No. 20, and were evaluated in the same manner as in example 1. As a result, the samples of the invention showed excellent results as in example 1.

### Example 4

Samples were prepared in the same manner as in example 2 except that the sensitizing dye No. 5 was replaced with a sensitizing dye No. 54, and were evaluated in the same manner as in example 2. As a result, the samples of the invention showed excellent results as in example 2.

What is claimed is:

1. A heat developable photosensitive material including a substrate having provided thereon at least one constituent layer, which contains a photosensitive silver halide, a non-photosensitive organic silver salt, a reducing agent for thermal developing and a binder,
wherein at least one reducing agent that does not form a dye at the time of thermal developing and at least one reducing agent forming a dye at the time of thermal developing that is more active than said at least one reducing agent that does not form a dye at the time of thermal developing are used as said reducing agent for thermal developing.

2. The heat developable photosensitive material of claim 1, wherein said at least one constituent layer is coated utilizing an organic solvent.

3. The heat developable photosensitive material of claim 1, wherein said at least one reducing agent that does not form a dye at the time of thermal developing is a compound represented by the following formula R1 and said at least one reducing agent forming a dye at the time of thermal developing is a compound represented by the following formula R2: 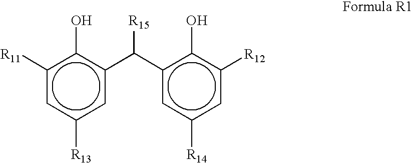
wherein, in formula R1, R₁₁ and R₁₂ independently represent a primary alkyl group; R₁₃ and R₁₄ independently represent a primary alkyl group; and R₁₅ represents a hydrogen atom or an alkyl group; and 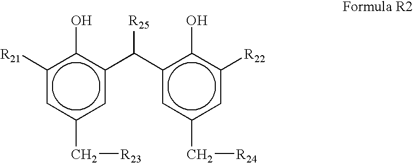
wherein, in formula R2, R₂₁ and R₂₂ independently represent a secondary or tertiary alkyl group; R₂₃ and R₂₄ independently represent a hydrogen atom, a hydroxy group, an alkoxy group, an aryloxy group, an alkylthio group, an arylthio group, an acyloxy group, an amino group or a heterocyclic group; and R₂₅ represents a hydrogen atom or an alkyl group.

4. The heat developable photosensitive material of claim 3, wherein R₂₁ or R₂₂ is a t-butyl group or a t-amyl group.

5. The heat developable photosensitive material of claim 1, wherein the amount of the reducing agent represented by formula R2 is 40 mol % or less of all the reducing agents.

6. The heat developable photosensitive material of claim 1, further comprising a developing accelerator.

7. The heat developable photosensitive material of claim 6, wherein said developing accelerator is a compound represented by at least one of the following formulae A-1 and A-2:
Q1-NHNH-Q2 Formula A-1
wherein, in formula A-1, Q1 represents an aromatic group or a heterocyclic group, bonded by a carbon atom to —NHNH-Q2; and Q2 represents a carbamoyl group, an acyl group, an alkoxycarbonyl group, an aryloxycarbonyl group, a sulfonyl group or a sulfamoyl group; and 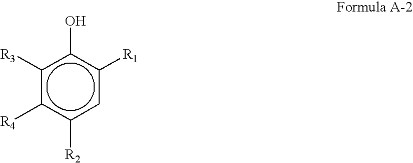
wherein, in formula A-2, R₁ represents an alkyl group, an acyl group, an acylamino group, a sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group or a carbonate ester group; R₃ and R₄ independently represent a group which can bond to a benzene ring; wherein R₃ and R₄ may bond to each other to form a condensed ring.

8. The heat developable photosensitive material of claim 1, further comprising a hydrogen bonding compound.

9. The heat developable photosensitive material of claim 8, wherein said hydrogen bonding compound is represented by the following formula D: 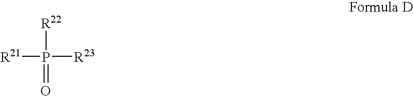
wherein, in formula D, R²¹ to R²³ independently represent an alkyl group, an aryl group, an alkoxy group, an aryloxy group, an amino group or a heterocyclic group.

10. The heat developable photosensitive material of claim 1, comprising a compound represented by the following formula H:
Q-(Y)n-C(Z₁)(Z₂)X Formula H:
wherein, in formula H, Q represents an alkyl group, an aryl group or a heterocyclic group; Y represents a divalent connecting group; n represents 0 or 1; Z₁ and Z₂ represent a halogen atom; and X represents a hydrogen atom or an electron-attractive group.

11. The heat developable photosensitive material of claim 1, wherein a total coated silver amount is 1.9 g/m² or less.

12. The heat developable photosensitive material of claim 1, wherein a thermal developing time is 16 seconds or less.

13. The heat developable photosensitive material of claim 1, comprising, as said binder, polyvinyl butyral in an amount from 50 to 100 wt % of all the binder components of a photosensitive layer.

14. The heat developable photosensitive material of claim 1, wherein said photosensitive silver halide is subjected to spectral sensitization within a region of from 700 to 1400 nm with a spectral sensitizing dye.

15. The heat developable photosensitive material of claim 1, subjected to spectral sensitization with at least one spectral sensitizing dye represented by any of formulas 3a, 3b, 3c and 3d: 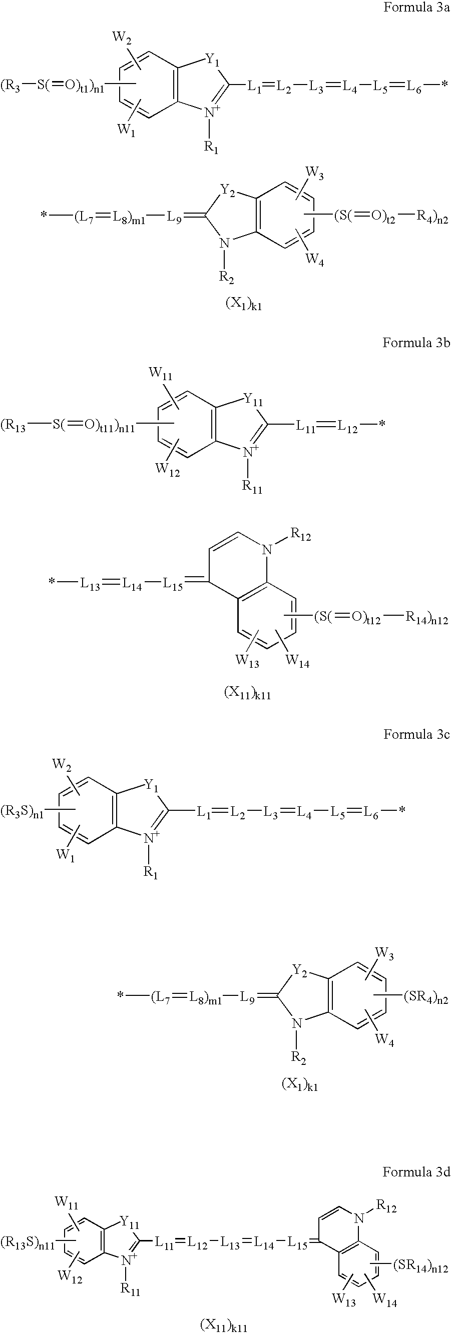
wherein Y₁, Y₂ and Y₁₁ independently represent an oxygen atom, a sulfur atom, a selenium atom or a —CH═CH— group; L₁ to L₉ and L₁₁ to L₁₅ independently represent a methine group; R₁, R₂, R₁₁ and R₁₂ independently represent an aliphatic group; R₃, R₄, R₁₃ and R₁₄ independently represent a lower alkyl group, a cycloalkyl group, an alkenyl group, an aralkyl group, an aryl group, or a heterocyclic group; W₁, W₂, W₃, W₄, W₁₁, W₁₂, W₁₃ and W₁₄ independently represent a hydrogen atom, a substituent or a non-metal atom group required for forming a condensed ring by a bonding between W₁ and W₂, W₃ and W₄, W₁₁ and W₁₂ or W₁₃ and W₁₄, or a non-metal atom group required for forming a 5-membered or 6-membered condensed ring by a bonding between R₃ and W₁, R₃ and W₂, R₁₃ and W₁₁, R₁₃ and W₁₂, R₄ and W₃, R₄ and W₄, R₁₄ and W₁₃, or R₁₄ and W₁₄; X₁ and X₁₁ independently represent an ion required for canceling a charge in a molecule; k₁ and k₁₁ independently represent a number of ions required for canceling a change in a molecule; ml represents 0 or 1; n₁, n₂, n₁₁ and n₁₂ independently represent 0, 1 or 2, wherein n₁ and n₂, or n₁₁ and n₁₂ are not 0 at the same time; and t1, t2, t11 and t12 independently represent an integer of 1 or 2.
